(19) United States
(12) Patent Application Publication
(10) Pub. No.: US 2013/0086085 A1
(43) Pub. Date: Apr. 4, 2013

(54) COMPUTER PRODUCT, ANALYSIS SUPPORT METHOD, ANALYSIS SUPPORT APPARATUS, AND SYSTEM

(71) Applicant: Shingo KATO, Yokohama (JP)

(72) Inventor: Shingo KATO, Yokohama (JP)

(73) Assignee: FUJITSU LIMITED, Kawasaki-shi (JP)

(21) Appl. No.: 13/572,726

(22) Filed: Aug. 13, 2012

(30) Foreign Application Priority Data
Sep. 29, 2011 (JP) 2011-215612

(51) Int. Cl. G06F 17/30

(52) U.S. Cl. 707/749; 707/736; 707/750; 707/E17.009

(57) ABSTRACT

A computer-readable recording medium has stored therein a program for causing a computer to execute an analysis support process that includes storing to a storage device, a name of a second process that is a process included among a plurality of processes called in response to execution of a program, the computer storing the name of the second process when a first process having a name that matches a keyword stored in a storage device is included among the processes.

### CROSS REFERENCE TO RELATED APPLICATIONS

This application is based upon and claims the benefit of priority of the prior Japanese Patent Application No. 2011-215612, filed on Sep. 29, 2011, the entire contents of which are incorporated herein by reference.

### FIELD

The embodiments discussed herein are related to supporting analysis of information processing.

### BACKGROUND

Technology that by information visualization and analysis of the execution state of a business process in an Information (IT) system, discovers where bottlenecks occur and supports effecting appropriate and effective improvements in operations is available. A business process is a business operation implemented by executing 2 or more tasks.

Taking a “money transfer operation” of a bank system as an example of a business process, a “money transfer operation” is executed by a series of tasks including, for example, login, designation of sending account, designation of receiving account, designation of amount, confirmation of balance, execution of transfer, confirmation of execution results, and logout. Here, a series of tasks executed to implement a business operation such as a “money transfer operation” is called a “process instance”.

Another technology collects transaction information concerning transactions between applications and/or network nodes in an IT system. A transaction is information transmission and task flow in an IT system, collectively as 1 processing unit, e.g., a series of tasks that are executed for one operation.

Here, it can be said that a series of tasks identified from transaction information collected from an IT system implementing a business process is a process instance of some business process. Therefore, the series of tasks identified from the transaction information collected from the IT system is correlated with the business process implemented by the IT system, thereby enabling process analysis to be performed.

However, since multiple business processes are typically in operation in an IT system, it is difficult to identify which tasks executed by the IT system correspond to which business process. Conventionally, technology exists that preliminarily prepares keywords related to the business processes, matches the names, etc. of tasks that have been executed by the IT system and the keywords, and correlates the tasks and the business processes executed by the IT system.

As a related conventional technology, for example, a variable classifying apparatus that infers the purpose of a variable used by a program, has a variable classification rule table that establishes relations between information related to the variables and, details of the variables or purposes of the variables. The variable classification apparatus collects the types of calculations to which the variables are applied by the program or information related to the variables, refers to the variable classification rule table concerning the collected variable information, and infers and classifies the details or the purpose of the variables used by the program.

For an example, refer to Japanese Laid-Open Patent Publication No. H11-203116.

Nonetheless, with the conventional technology, the difficulty of identifying which tasks executed by the system correspond to which business process remains. For example, an expression unrelated to the business process may be linked to the name of a task executed by the system. Further, the name of a task may not match one of the preliminarily prepared keywords, making it impossible to identify which to which business process the task belongs.

### SUMMARY

According to an aspect of an embodiment, a computer-readable recording medium has stored therein a program for causing a computer to execute an analysis support process that includes storing to a storage device, a name of a second process that is a process included among a plurality of processes called in response to execution of a program, the computer storing the name of the second process when a first process having a name that matches a keyword stored in a storage device is included among the processes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of an analysis support method according to a first embodiment;

FIG. 2 is a diagram depicting an example of system configuration of a system 200:

FIG. 3 is a block diagram depicting an example of a hardware configuration of an analysis support apparatus 100:

FIG. 4 is a diagram depicting an example of the contents of a keyword table 220:

FIG. 5 is a diagram of a first example of process instance data:

FIG. 6 is a block diagram of an example of a functional configuration of the analysis support apparatus 100:

FIGS. 7A, 7B, 8A, and 8B are diagrams depicting an example of the contents of a business process pattern table 700;

FIG. 9 is a diagram depicting an example of the contents of a business process instance DB 900;

FIG. 10 is diagram depicting a first example of the contents of a weight table 1000;

FIGS. 11A and 11B are diagrams depicting an updating example for the business process pattern table 700;

FIG. 12 is a diagram depicting an execution order of a series of activities;

FIGS. 13A, 13B, and 13C are diagrams depicting an example of the contents of an occurrence count table 1300;

FIG. 14 is a diagram of a second example of the contents of the weight table 1000;

FIG. 15 is a diagram of a second example of the process instance data;

FIGS. 16A and 16B are diagrams of a third example of the contents of the business process pattern table 700;

FIG. 17 is a diagram depicting a third example of the contents of the weight table 1000;

FIG. 18 is a diagram depicting a first example of updating of the weight table 1000;

FIG. 19 is a diagram depicting an example of updating of the occurrence count table 1300;

FIG. 20 is a diagram depicting a second example of updating of the weight table 1000;

FIG. 21 is a flowchart of an example of the procedure of analysis support processing by the analysis support apparatus 100;

FIG. 22 is a flowchart of an example of update processing;

FIG. 23 is a flowchart of an example of correlation processing;

FIG. 24 is a flowchart of an example of a first level of association calculation processing/correlation processing;

FIG. 25 is a flowchart of an example of a second level of association calculation processing/correlation processing;

FIG. 26 is a flowchart of an example of a third level of association calculation processing/correlation processing;

FIGS. 27 and 28 are flowcharts of an example of the first weight calculation processing;

FIG. 29 is a flowchart of an example of the second weight calculation processing; and

FIG. 30 is a flowchart of an example of generation processing for the keyword table 220.

### DESCRIPTION OF EMBODIMENTS

Preferred embodiments of will be explained with reference to the accompanying drawings.

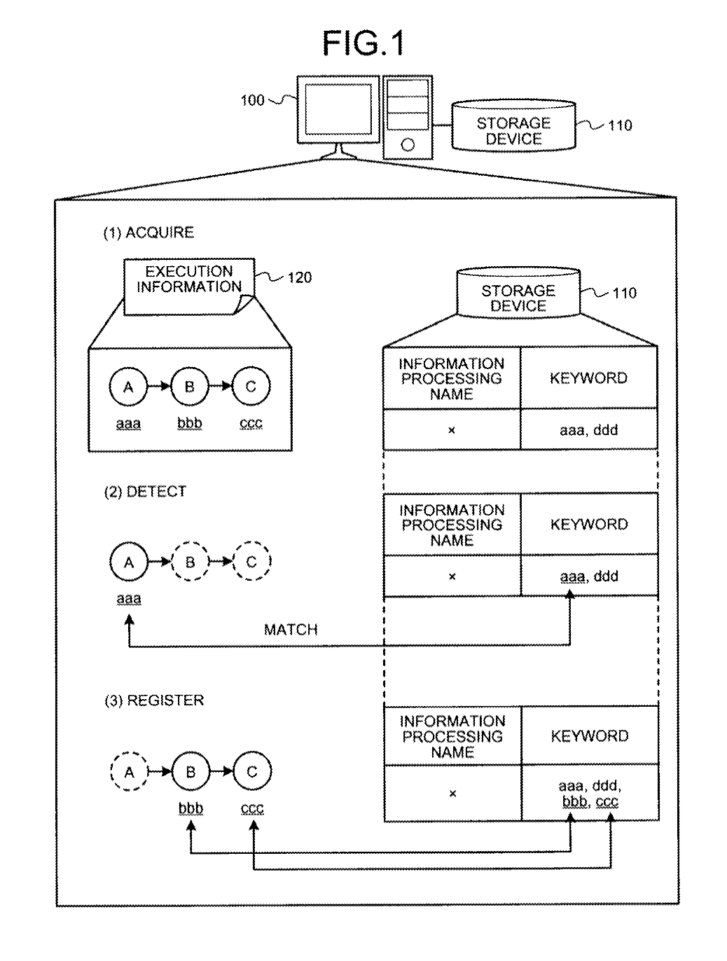

FIG. 1 is a diagram depicting an example of an analysis support method according to a first embodiment. In FIG. 1, an analysis support apparatus 100 is a computer that supports analysis of information processing implemented in a system. Here, a system is a system that includes hardware, software, and a network, such as a bank system, a government system, an enterprise system, etc. Further, information processing is processing implemented by executing 2 or more tasks, such as a business operation in a bank system, government system, an enterprise system, etc.

The analysis support apparatus 100 has a storage device 110. The storage device 110 is a storage apparatus storing keywords related to the information processing implemented in the system. A keyword, for example, is expressed by 1 or more characters or symbols, or a combination thereof. A word used in the operation name is used as a keyword related to the information processing.

For example, from among a series of tasks executed by the system, detection of a task having a name that matches a keyword in the storage device 110 enables correlation of a series of tasks executed by the system and a given business operation. On the other hand, an expression that is not related to a business operation, such as a servlet name, the Bean name of Enterprise Java Beans (EJB) (“Java” is a registered trademark), a Web service name, etc. is often given as the name of a task executed when the business operation is implemented. Consequently, advanced, comprehensive preparation of keywords for correlating the given business operation and the series of tasks executed by the system is difficult.

Thus, when a task name among the series of tasks matches a preliminarily prepared keyword, the analysis support apparatus 100 accumulates in the storage device 110, other task names included in the series of tasks, even if the task name does not coincide with a keyword. Thus, keyword candidates related to the given information processing are comprehensively collected. Hereinafter, an example of a procedure of analysis support processing by the analysis support apparatus 100 will be described.

(1) The analysis support apparatus 100 acquires execution information related to a series of tasks executed in a system. Here, execution information is, for example, information that includes information identifying the names of the tasks included in the series of tasks, the execution sequence of the tasks, etc. The execution information, for example, is collected from the hardware and software in the system executing the series of tasks.

In the example depicted in FIG. 1, execution information 120 that includes the names “aaa”, “bbb”, and “ccc” of tasks included in a series of tasks A, B, C executed in the system is acquired.

(2) The analysis support apparatus 100, based on the storage contents of the storage device 110, detects from among the series of tasks, a first task having a name that matches a keyword registered in the storage device 110. Here, a task name that matches a keyword is, for example, a task name that coincides with or is similar to a keyword.

In the example depicted in FIG. 1, “aaa” and “ddd” are stored in the storage device 110 as keywords related to information processing X executed in the system. Thus, from among the series of tasks A, B, C executed in the system, task A, which has a name matching keyword “aaa” registered in the storage device 110, is detected.

(3) If a first task has been detected, the analysis support apparatus 100 registers to the storage device 110 as a keyword related to the information processing, the name of a second task, which is different from the first task and among the series of tasks executed in the system. In other words, if even 1 task name among the series of tasks coincides with a preliminarily prepared keyword related to the information processing, tasks that are included in the series of tasks have the potential of being related to the information processing even if the respective names do not coincide with a keyword. Therefore, the tasks are accumulated in the storage device 110.

In the example depicted in FIG. 1, since task A, which matches keyword “aaa”, is detected from among the series of tasks A, B, C executed in the system, the names “bbb” and “ccc” of tasks B and C, which are different from task A, are registered to the storage device 110.

The first embodiment enables task names that do not match a keyword to be accumulated as keywords related to the information processing, if a task name among the series of tasks executed by the system matches a preliminarily prepared keyword.

Consequently, keyword candidates related to the given information processing (e.g., information processing X) can be comprehensively collected. Further, the keyword candidates related to the given information processing and accumulated in the storage device 110 can be manually confirmed and a keyword related to the given information processing can be extracted. As a result, keywords related to the given information processing can be comprehensively prepared, and the given information processing and the series of tasks executed by the system can be correlated.

A case where the analysis support apparatus 100 described in the first embodiment is applied to a system 200 will be described. Description of portions identical to those described in the first embodiment will be omitted.

In a second embodiment, description will be given with respect to a business process (business operation) implemented by an execution of 2 or more tasks, as information processing implemented by the system 200. Each of the tasks executed by the system 200 is referred to as an “activity”. In other words, the business process is formed by multiple activities. Further, in the description, a series of activities executed by the system 200 may be indicated as a “process instance”.

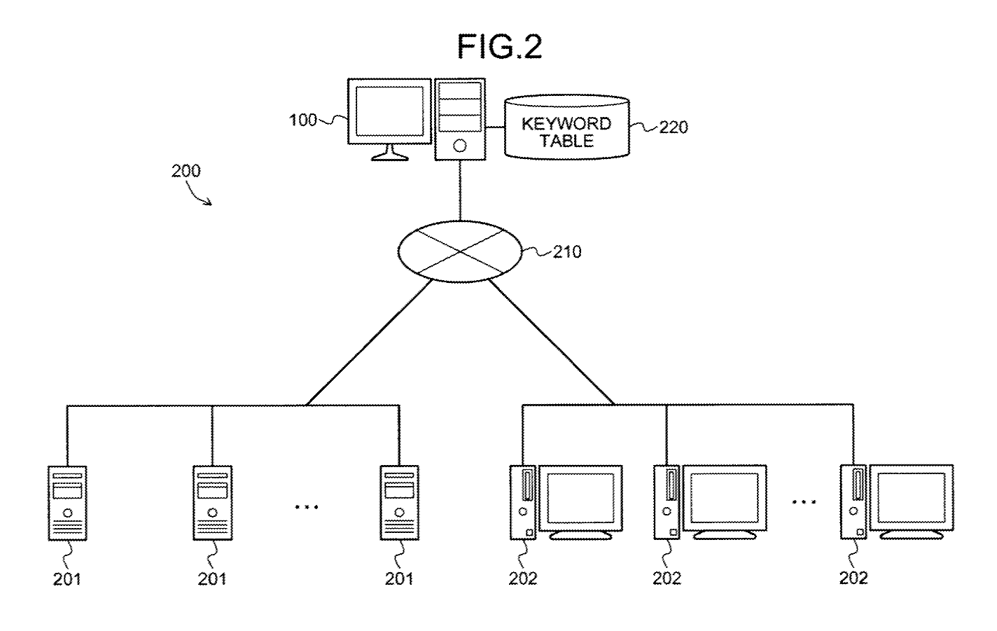

FIG. 2 is a diagram depicting an example of system configuration of the system 200. In FIG. 2, the system 200 is of a configuration that includes the analysis support apparatus 100, multiple business servers 201, and multiple business terminals 202. In the system 200, the analysis support apparatus 100, the business servers 201, and the business terminals 202 are respectively connected through a wired or a wireless network 210, enabling communication therebetween. The network 210 is, for example, a local area network (LAN), a wide area network (WAN), the internet, etc.

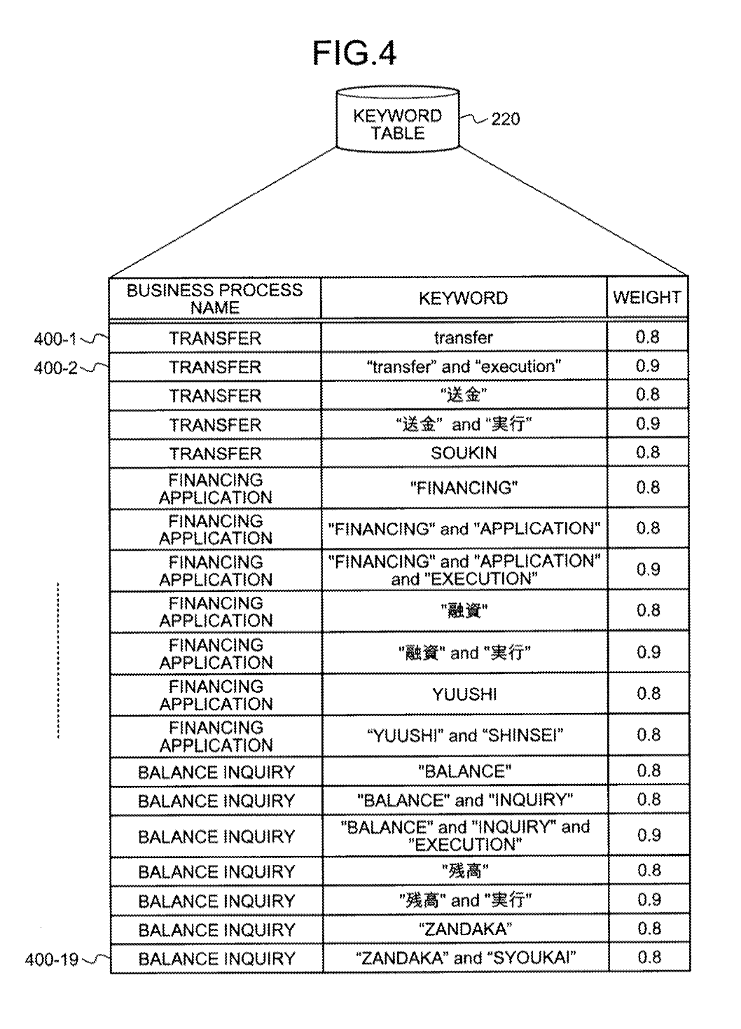

Here, the analysis support apparatus 100 has a keyword table 220 and is a computer that supports analysis of a business operation implemented in the system 200. The analysis support apparatus 100 is for example, a personal computer (PC) or a notebook PC used by a manager of the system 200. Details of the keyword table 220 will be described with reference to FIG. 4.

Each business server 201 is a computer having a function of executing an activity. For example, a business system is realized by 1 or more of the business servers 201. A business system is, for example, a system for implementing business operations at a bank, a government office, a corporate enterprise, etc. The business servers 201 are, for example, Web servers, application servers, data servers, etc.

Each business terminal 202 is a computer used by a user of the business system and, for example, consequent to operation by a user and through the network 210, operates the business system operating on the business servers 201. Each business terminal 202 is, for example, a PC or a notebook PC used by a user of the business system.

The analysis support apparatus 100 acquires process instance data that indicates the series of activities executed by the system 200. For example, the analysis support apparatus 100 receives the process instance data through the network 210, from the business servers 201 operated by the business system.

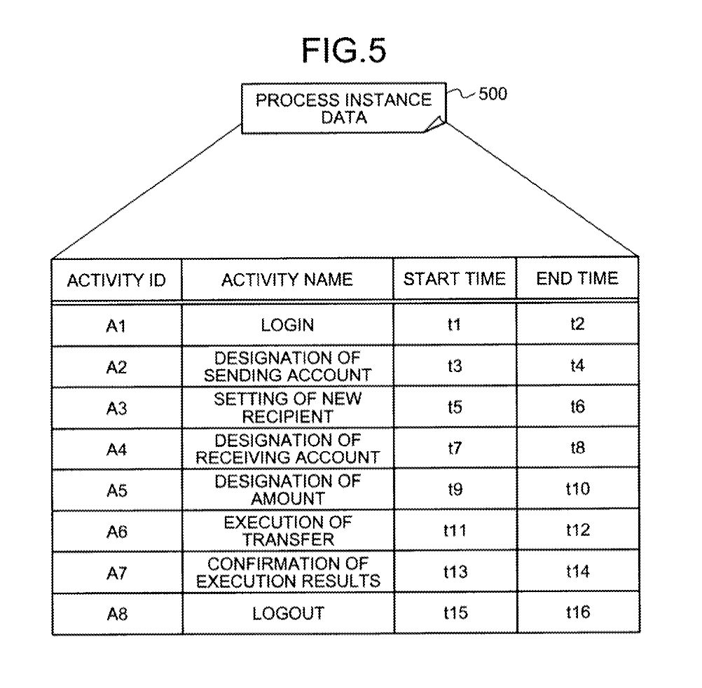

Transfer of the process instance data from the business servers 201 to the analysis support apparatus 100 is, for example, performed using a communication means employing File Transfer Protocol (FTP), Java Message Service (JMS), a web server, etc. The process instance data will be described with reference to FIG. 5.

In the system 200, configuration may be such that the business system is operated on the analysis support apparatus 100 or on a business terminal 202. For example, when the business system is operated on a business terminal 202, the business terminal 202, consequent to operation by the user, can operate the business system operating on the business terminals 202.

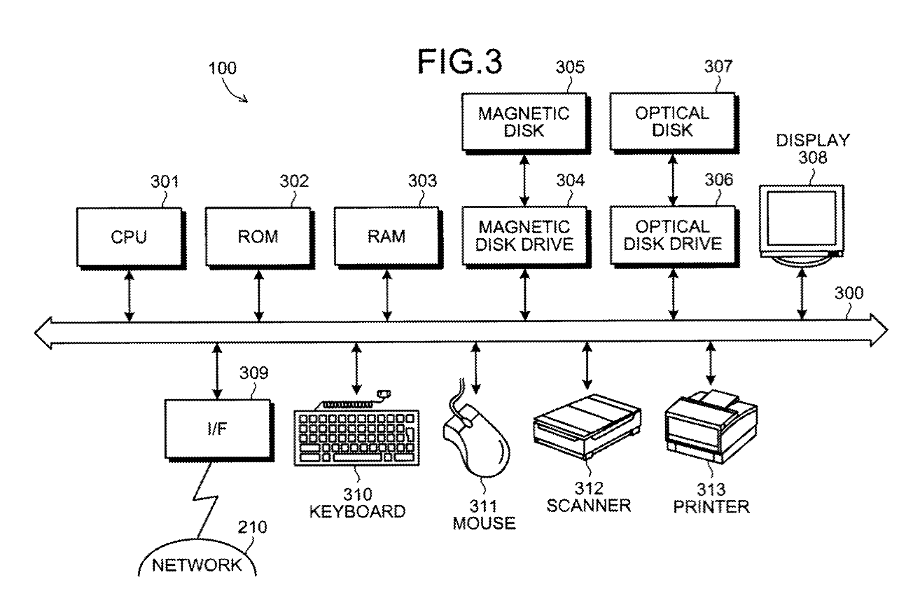

FIG. 3 is a block diagram depicting an example of a hardware configuration of the analysis support apparatus 100. In FIG. 3, the analysis support apparatus 100 includes a central processing unit (CPU) 301, a read-only memory (ROM) 302, a random access memory (RAM) 303, a magnetic disk drive 304, a magnetic disk 305, an optical disk drive 306, an optical disk 307, a display 308, an interface (I/F) 309, a keyboard 310, a mouse 311, a scanner 312, and a printer 313, respectively connected by a bus 300.

The CPU 301 governs overall control of the analysis support apparatus. The ROM 302 stores therein programs such as a boot program. The RAM 303 is used as a work area of the CPU 301. The magnetic disk drive 304, under the control of the CPU 301, controls the reading and writing of data with respect to the magnetic disk 305. The magnetic disk 305 stores therein data written under control of the magnetic disk drive 304.

The optical disk drive 306, under the control of the CPU 301, controls the reading and writing of data with respect to the optical disk 307. The optical disk 307 stores therein data written under control of the optical disk drive 306, the data being read by a computer.

The display 308 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 308.

The I/F 309 is connected to the network 210 such as a local area network (LAN), a wide area network (WAN), and the Internet through a communication line and is connected to other apparatuses through the network 210. The I/F 309 administers an internal interface with the network 314 and controls the input/output of data from/to external apparatuses. For example, a modem or a LAN adaptor may be employed as the I/F 309.

The keyboard 310 includes, for example, keys for inputting letters, numerals, and various instructions and performs the input of data. Alternatively, a touch-panel-type input pad or numeric keypad, etc. may be adopted. The mouse 311 is used to move the cursor, select a region, or move and change the size of windows. A track ball or a joy stick may be adopted provided each respectively has a function similar to a pointing device.

The scanner 312 optically reads an image and takes in the image data into the analysis support apparatus. The scanner 312 may have an optical character reader (OCR) function as well. The printer 313 prints image data and text data. The printer 313 may be, for example, a laser printer or an ink jet printer.

The analysis support apparatus 100 may be configured such that among the components above, for example, the optical disk drive 306, the optical disk 307, the scanner 312, and the printer 313 are omitted. Further, the business servers 201 and the business terminals 202 depicted in FIG. 2 may be realized by a hardware configuration identical to that of the analysis support apparatus 100.

The keyword table 220 depicted in FIG. 2 will be described. Here, an example where business processes subject to analysis include (money) “transfer”, “balance inquiry”, and “financing application”.

FIG. 4 is a diagram depicting an example of the contents of the keyword table 220. In FIG. 4, a keyword table has fields for business process names, keywords, and weights. By entering information into each of the fields, keyword data 400-1 to 400-19 are stored as records.

Here, a business process name is the name of a business process implemented by the business system. A keyword is a keyword related to one of the business processes. A weight is a value indicative of the degree of relevancy between a business process and a keyword. Here, the greater the value of the weight is, the higher the degree of relevancy between a business process and a keyword is. The minimum value of the weight is “0” and the maximum value is “1”.

Taking keyword data 400-1 as an example, the keyword “transfer” related to the business process “transfer”, and the weight “0.8” indicative of the degree of relevancy between the business process “transfer” and the keyword “transfer” are indicated. Taking keyword data 400-2 as an example, the keywords “transfer” and “execution” related to the business process “transfer”, and the weight “0.9” indicative of the degree of relevancy between the business process “transfer” and the keywords “transfer” and “execution” are indicated. Symbols as well as non-English characters such as Kanji may also be used as keywords.

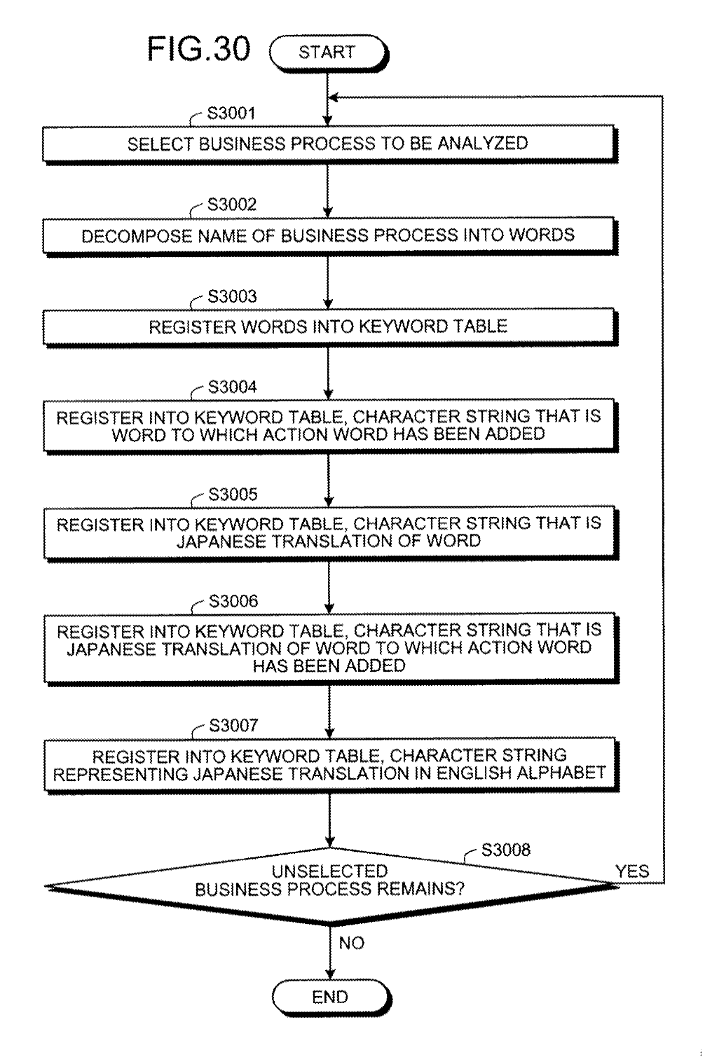

The keyword table 220, for example, is stored to a storage apparatus such as the RAM 303, the magnetic disk 305, and the optical disk 307 depicted in FIG. 3. Generation processing for generating the keyword table 220 will be described with reference to a flowchart depicted in FIG. 30.

FIG. 5 is a diagram of a first example of the process instance data. In FIG. 5, process instance data 500 is information for a series of activities A1 to A8 executed by the system 200. For example, the process instance data 500 includes the activity ID, the activity name, the start time, and the end time of each activity A1 to A8.

Here, an activity ID is an identifier of an activity that is used for explanation in the present specification. An activity name is the name of an activity. A start time is the time when the execution of an activity started. An end time is the time when the execution of an activity ended. Here, concerning “$” of each time t$, the more time that elapses, the greater the value of “$” is. For example, by referring to the start time of each activity, the execution sequence of the activities in the series of activities A1 to A8 can be identified.

For instance, for activity A1, the activity name “login”, the start time “t1”, and the end time “t2” are indicated. Further, for activity A2, the activity name “designation of sending account”, the start time “t3”, and the end time “t4” are indicated.

In addition to the information above, the process instance data 500 may include, for example, identifiers of the machines that executed the activities A1 to A8. The internet protocol (IP) address of a business server 201 that executed the activities A1 to A8 can be used as a machine identifier.

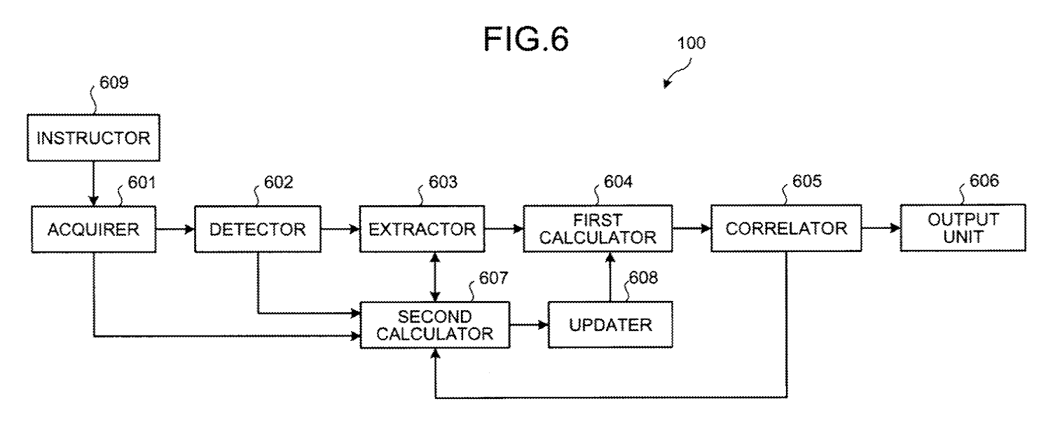

An example of a functional configuration of the analysis support apparatus 100 according to the second embodiment will be described. FIG. 6 is a block diagram of an example of a functional configuration of the analysis support apparatus 100. In FIG. 6, the analysis support apparatus 100 includes an acquirer 601, a detector 602, an extractor 603, a first calculator 604, a correlator 605, an output unit 606, a second calculator 607, an updater 608, and an instructor 609. These functions (the acquirer 601 to the instructor 609) forming a controller, for example, are implemented by executing on the CPU 301, a program stored in a storage apparatus such as the ROM 302, the RAM 303, the magnetic disk 305, and the optical disk 307 depicted in FIG. 3 or by the I/F 309. Processing results of each of the functional components are, for example, stored to a storage apparatus such as the RAM 303, the magnetic disk 305, and the optical disk 307.

The acquirer 601 has a function of acquiring process instance data for a series of activities executed by the system 200. For example, the acquirer 601 acquires the process instance data 500 by receiving the process instance data 500 (see FIG. 5) from a business server 201, through the network 210.

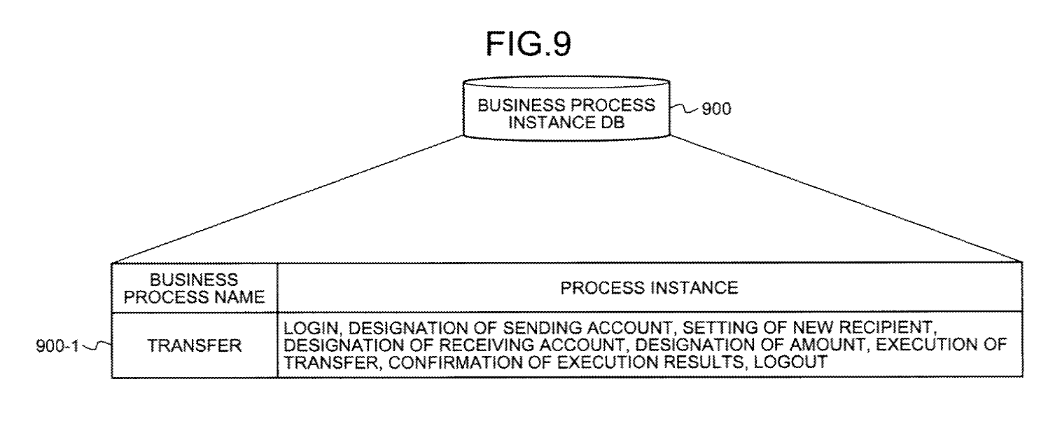

The acquirer 601 may acquire the process instance data 500, which has been directly input to the analysis support apparatus 100 by user input via the keyboard 310 and/or the mouse depicted in FIG. 3. The acquirer 601 may acquire the process instance data 500 by extracting the process instance data 500 from a database (e.g., a business process instance database (DB) 900 described hereinafter with reference to FIG. 9) or a library (not depicted).

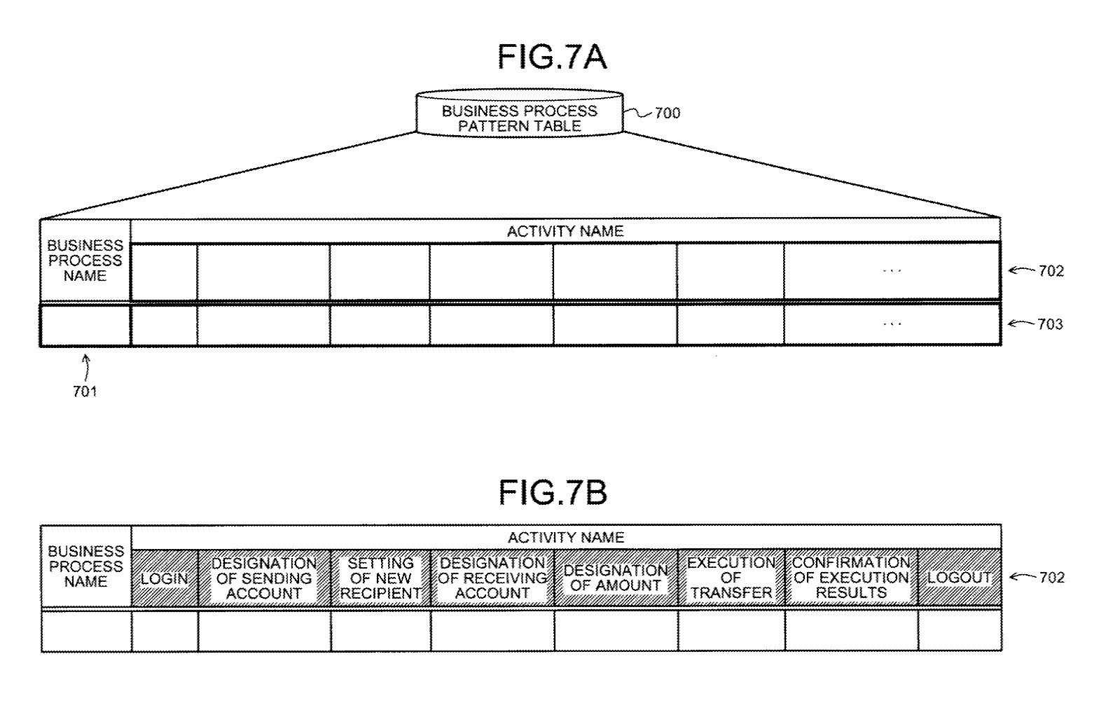

The names of the activities among the series of activities, identified from the acquired process instance data are, for example, registered to a business process pattern table 700 depicted in FIGS. 7A and 7B. The business process pattern table 700, for example, is implemented by a storage apparatus such as the RAM 303, the magnetic disk 305, and the optical disk 307.

The business process pattern table 700 is a table of weights indicative of the degrees of relevancy between a business process and each activity of a series of activities. Here, an example of the contents of the business process pattern table 700 will be described.

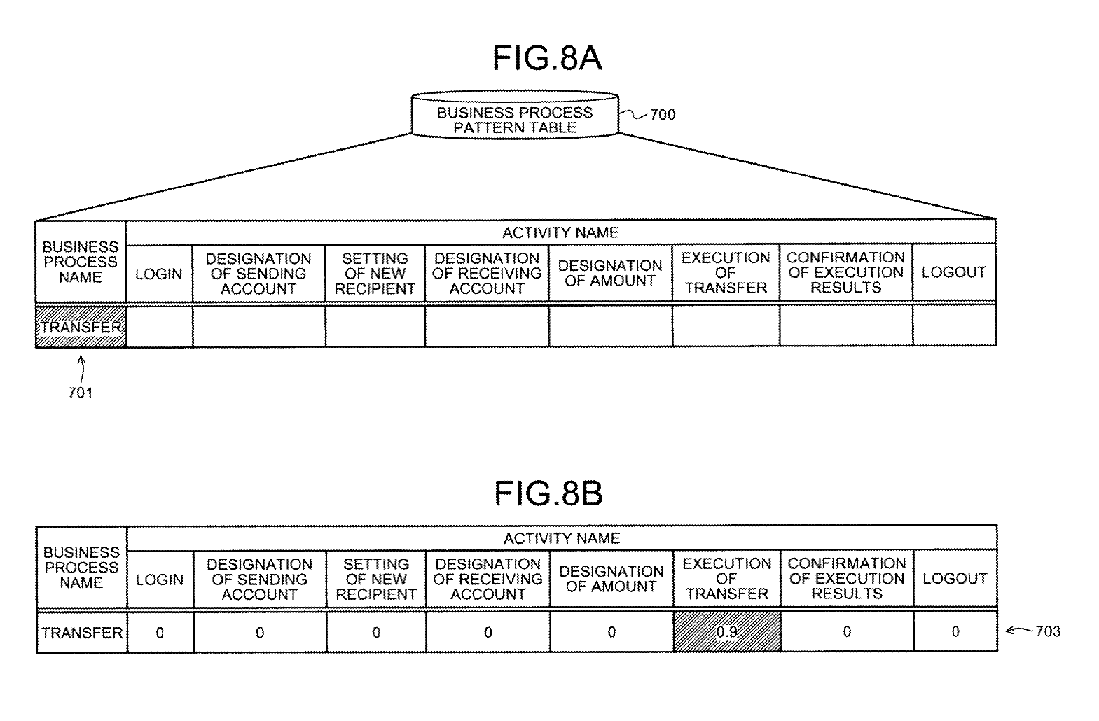

FIGS. 7A, 7B, 8A, and 8B are diagrams depicting an example of the contents of the business process pattern table 700. In FIG. 7A, the business process pattern table 700 has fields 701 to 703 (indicated by bold lines in the figure). Each field 701 is a field for a business process name. The fields 702 are fields for activity names. The fields 703 are fields for weights.

Activity names identified from the acquired process instance data are registered into the fields 702 of the business process pattern table 700. Taking the process instance data 500 as an example, the activity names include “login”, “designation of sending account”, “setting of new recipient”, “designation of receiving account”, “designation of amount”, “execution of transfer”, “confirmation of execution results”, and “logout”.

Therefore, in FIG. 7B, activity names identified from the process instance data 500 are registered into the fields 702 of the business process pattern table 700. At this point in time, the fields 701 and 703 are empty (no entry has been made).

In the description hereinafter, unless specified otherwise, the series of activities identified from the acquired process instance data is indicated as “activities A1 to An” (n: natural number of 2 or more). An arbitrary activity among the activities A1 to An is indicated as “activity Ai” (i=1, 2, . . . , n).

The detector 602 depicted in FIG. 6 has a function of detecting from among the activities A1 to An, a first activity whose name matches a keyword (hereinafter, “keyword K”) stored in the keyword table 220.

For example, the detector 602 may refer to the business process pattern table 700 depicted in FIGS. 7A and 7B, and detect as the first activity, an activity whose name coincides with a keyword K. The detector 602 may detect an activity whose name is included in a keyword K. Further, the detector 602 may detect an activity whose name includes a keyword K.

Taking the process instance data 500 as an example, the name “execution of transfer” of activity A6 matches the keywords “transfer” and “execution” stored in the keyword table 220. Therefore, the detector 602 detects activity A6 from among the series of activities A1 to A8.

Here, if a first activity is detected, for example, the business process name corresponding to the keyword K matching the name of the first activity is registered into the field 701 of the business process pattern table 700.

For example, the business process name that corresponds to the keywords “transfer” and “execution” matching the name “execution of transfer” of activity A6 is “transfer”. Therefore, in FIG. 8A, the business process name “transfer” is registered into the field 701 in the business process pattern table 700.

The extractor 603 has a function of extracting, if a first activity is detected, a weight that is indicative of the degree of relevancy between a keyword K that matches the name of the first activity and a business process, the weight being extracted from the keyword table 220. Here, the business process is the business process of the name that corresponds to the keyword that matches the name of the first activity.

In the description hereinafter, unless otherwise specified, business processes registered in the business process pattern table 700 are indicated as “business processes P1 to Pm” (m: natural number of 1 or more). An arbitrary business process among the business processes P1 to Pm is indicated as “business process Pj” (j=1, 2, . . . , m).

Here, description will be given for the example above where activity A6 is detected. In this case, the extractor 603 extracts from the keyword table 220, a weight “0.9” that is indicative of the degree of relevancy between the business process of the name “transfer” and the keywords “transfer” and “execution” that match the name (“execution of transfer”) of activity A6.

The extracted weight indicative of the degree of relevancy between a keyword K matching the name of the first activity and a business process Pj is, for example, registered to the business process pattern table 700. For example, in FIG. 8B, the extracted weight “0.9” is registered into the field 703 that corresponds to the activity name “execution of transfer” in the business process pattern table 700. In the business process pattern table 700, “0” is registered into fields 703 that correspond to activity names that remain, exclusive of the activity name “execution of transfer”.

The first calculator 604 has a function of calculating a level of association indicative of the degree of relevancy between the business process Pj and the activities A1 to An. For example, the first calculator 604, based on a weight indicative of the degree of relevancy between the business process Pj and the name of each activity Ai, calculates a level of association indicative of the degree of relevancy between the business process Pj and the activities A1 to An.

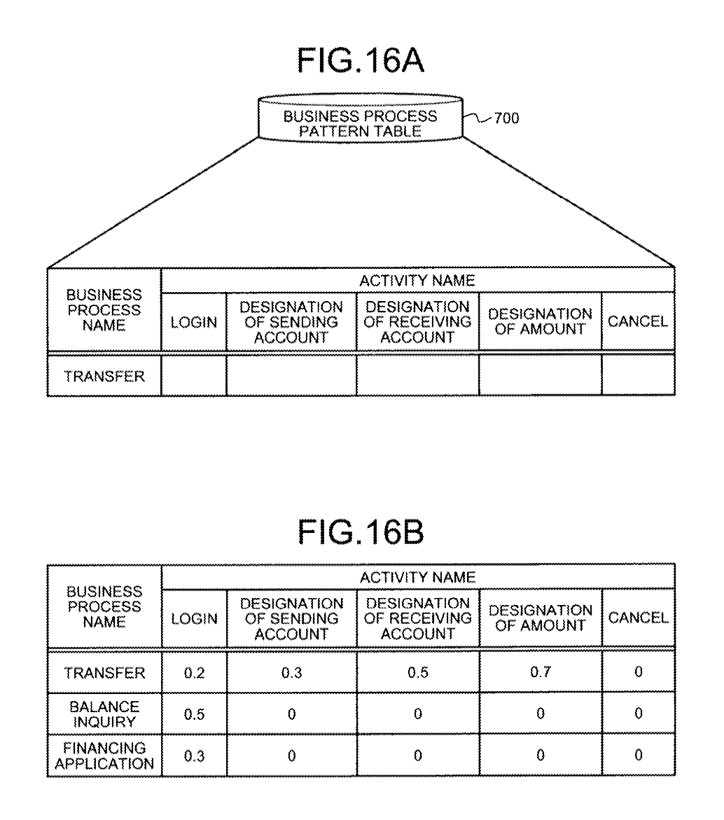

Weights indicative of the degrees of relevancy between the business process Pj and the name of each activity Ai are, for example, identified by referring to the business process pattern table 700. Although detailed description will be given with reference to FIG. 16 hereinafter, calculation processing by the first calculator 604, for example, is performed based on the contents of the business process pattern table 700 after updating by the updater 608.

The correlator 605 has a function of correlating the business process Pj and the activities A1 to An, based on each calculated level of association (hereinafter, “level of association Vj”) indicative of the degrees of relevancy between the business process Pj and each of the activities A1 to An. For example, configuration may be such that if the level of association Vj is greater than or equal to a given threshold Vth, the correlator 605 correlates the business process Pj and the activities A1 to An.

The threshold Vth can be arbitrarily set and for example, if the level of association Vj becomes greater than or equal to the threshold Vth, is set to indicate that the activities A1 to An are 1 process instance of the business process Pj. The threshold Vth is, for example, stored to a storage apparatus such as the ROM 302, the RAM 303, the magnetic disk 305, and the optical disk 307.

When correlation processing by the correlator 605 is performed, for example, new process instance data may be provided and the contents of the business process pattern table 700 may be initialized. Nonetheless, the business process pattern table 700 may be generated for each process instance data.

The output unit 606 has a function of outputting correlation results. The form of output may be, for example, display on the display 308, printout at the printer 313, and transmission to an external apparatus via the I/F 309 as well as storage to a storage area of, for example, the RAM 303, the magnetic disk 305, and the optical disk 307.

For example, the output unit 606 may store correlation results to a business process instance DB 900 depicted in FIG. 9. The business process instance DB 900 is, for example, implemented by a storage apparatus such as the RAM 303, the magnetic disk 305, and the optical disk 307. Here, the business process instance DB 900 will be described.

FIG. 9 is a diagram depicting an example of the contents of the business process instance DB 900. In FIG. 9, the business process instance DB 900 has fields for business process names and process instances. By entering information into the fields, business process instance data is stored as records (e.g., business process instance data 900-1).

Here, a business process name is the name of a business process implemented in the system 200. A process instance is a series of activities correlated with a business process. In the example depicted in FIG. 9, the business process instance data 900-1, which is the result of correlating the business process of the name “transfer” and the activities A1 to A8 identified from the process instance data 500, is stored.

For example, the business process instance data 900-1 indicates the names of the activities “login, designation of sending account, setting of new recipient, designation of receiving account, designation of amount, execution of transfer, execution result, confirmation of execution result, and logout” correlated with the business process of the name “transfer”.

If correlation of the activities A1 to An and the business process Pj is not performed by the correlator 605, “undetermined” is entered into the business process name field of the business process instance DB 900. The names of the activities A1 to An are entered into the process instance field and the business process instance data is stored as records.

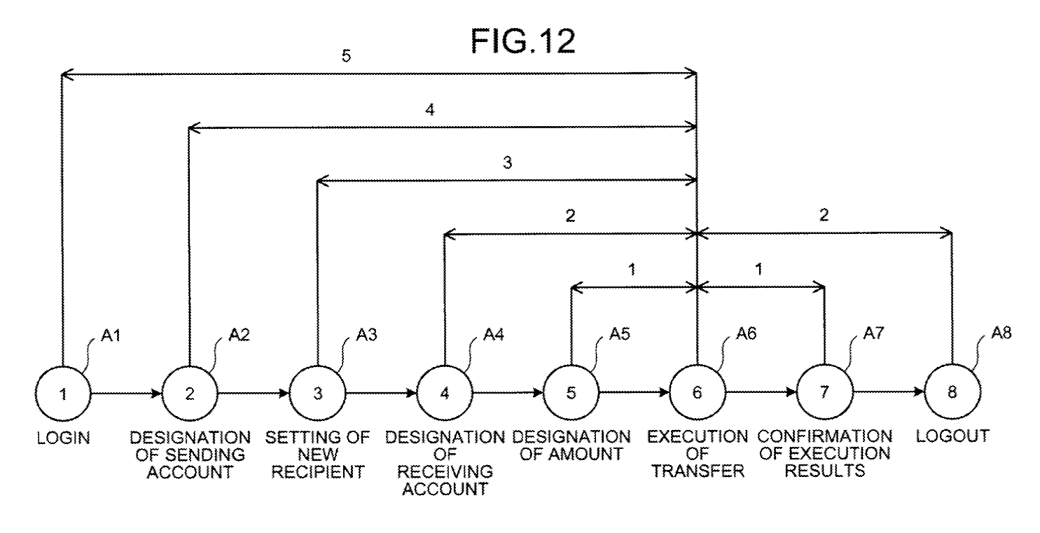

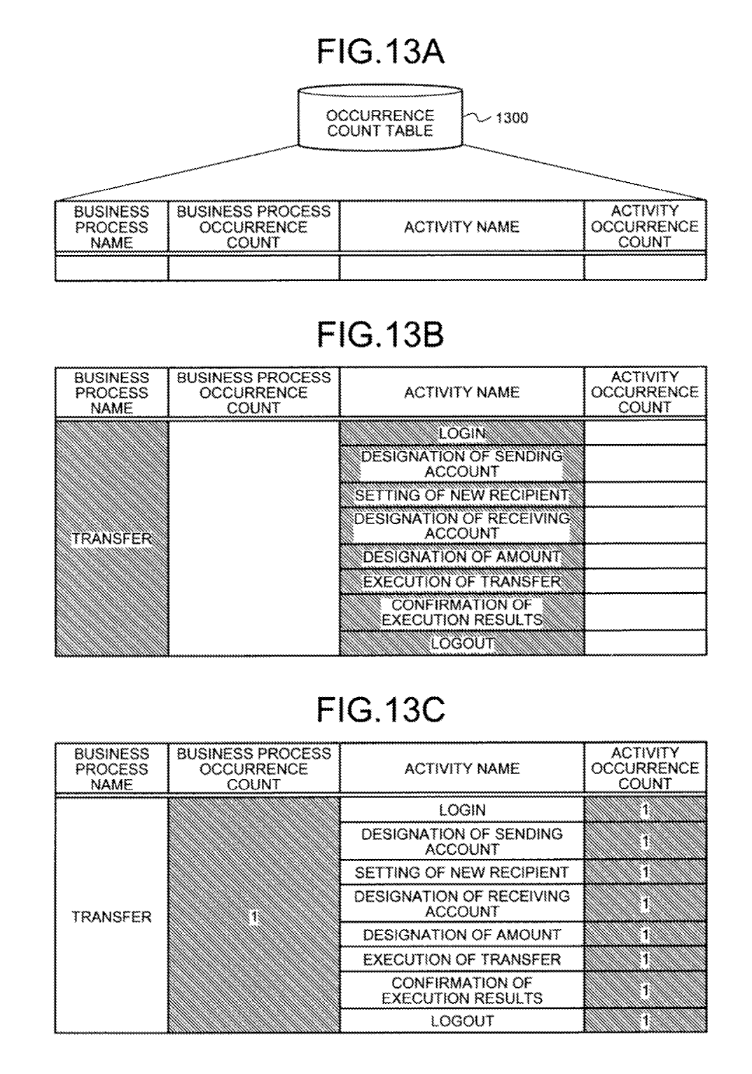

The second calculator 607 depicted in FIG. 6 has a function of calculating a weight indicative of the degree of relevancy between the name of an activity Ai and the business process Pj. Processing details of the second calculator 607 will be described with reference to FIGS. 12 and 13.

The weight indicative of the degree of relevancy between the name of the first activity and the business process Pj is identified from the keyword table 220. Therefore, the second calculator 607 may calculate a weight indicative of the degree of relevancy between the business process Pj and the name of a second activity that is among the activities A1 to An and different from the first activity.

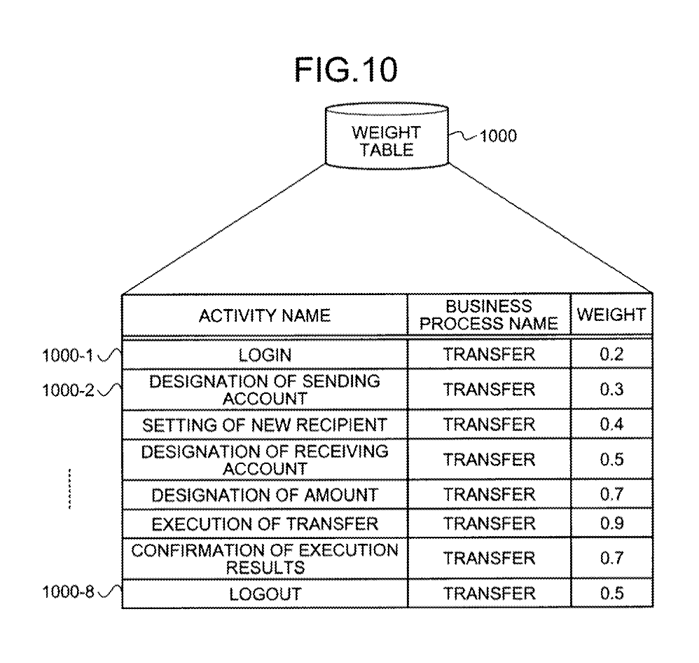

The calculated weight indicative of the degree of relevancy between the name of an activity Ai and the business process Pj is, for example, stored to a weight table 1000 depicted in FIG. 10. The weight table 1000 is implemented by a storage apparatus such as the RAM 303, the magnetic disk 305, and the optical disk 307. Here the weight table 1000 will be described.

FIG. 10 is diagram depicting a first example of the contents of the weight table 1000. In FIG. 10, the weight table 1000 has fields for activity names, business process names, and weights. By entering information into the fields, weight data 1000-1 to 1000-8 is stored as records. Here, an activity name is the name of an activity. A business process name is the name of a business process. A weight is a value indicative of the degree of relevancy between an activity name and a business process.

Taking weight data 1000-1 as an example, the weight “0.2” indicative of the degree of relevancy between the activity name “login” and the business process of the name “transfer” is indicated. Taking weight data 1000-2 as an example, the weight “0.3” indicative of the degree of relevancy between the activity name “designation of sending account” and the business process of the name “transfer” is indicated.

The updater 608 depicted in FIG. 6 has a function of updating the contents of the business process pattern table 700, based on the calculated weight indicative of the degree of relevancy between the name of an activity Ai and the business process Pj.

For example, the updater 608 detects the activity name matching the name of the activity Ai, from the weight table 1000 depicted in FIG. 10. Here, if an activity is detected, the updater 608 extracts a weight indicative of the degree of relevancy with the business process corresponding to the detected activity name.

The updater 608 registers to the business process pattern table 700, the extracted weight indicative of the degree of relevancy with the business process. If such a weight has already been registered, the updater 608 may determine whether to register the extracted weight.

For example, if the extracted weight is greater than the weight already registered, the updater 608 may determine to register the extracted weight into the business process pattern table 700. Here, an updating example for the business process pattern table 700 will be described.

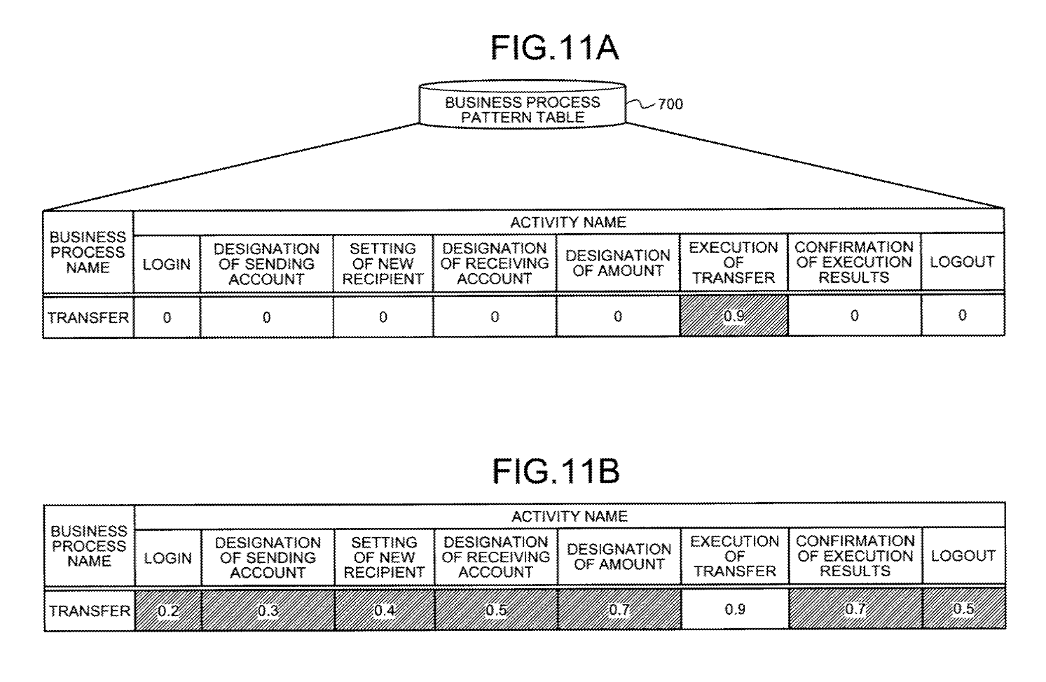

FIGS. 11A and 11B are diagrams depicting an updating example for the business process pattern table 700. FIG. 11A depicts the business process pattern table 700 before updating. FIG. 11B depicts the business process pattern table 700 after updating.

For example, the weights extracted from the weight table 1000 depicted in FIG. 10 and indicative of the degrees of relevancy between the business process of the name “transfer” and the name of each activity Ai are registered. However, the weight indicative of the degree of relevancy with the name “execution of transfer” of activity A6 is not updated.

The instructor 609 depicted in FIG. 6 has a function of instructing re-evaluation of a series of activities for which correlation processing has been executed with respect to a business process Pj. For example, the instructor 609 may instruct re-evaluation of a series of activities identified from the business process instance data stored in the business process instance DB 900 depicted in FIG. 9. In this case, the instructor 609 may regard the business process instance data of a given the business process name or business process instance data in which the business process name is “undetermined” to be subject to re-evaluation.

The timing of a re-evaluation instruction can be arbitrarily set. For example, the instructor 609 may periodically (e.g., every Monday, every 1st of the month, etc.) instruct re-evaluation of business process instance data. The instructor 609 may instruct re-evaluation of the business process instance data each time the contents of the weight table 1000 are updated. Further, the instructor 609 may instruct re-evaluation of the business process instance data when a re-evaluation instruction is received consequent to user input.

In the case of a re-evaluation instruction, for example, the acquirer 601 acquires business process instance data from the business process instance DB 900. The names of the activities in the series of activities, identified from the business process instance data are registered into the business process pattern table 700.

An example of the processing by the second calculator 607 will be described.

A first example of processing by the second calculator 607 will be described where a weight indicative of the degree of relevancy between the name of the second activity and the business process Pj is calculated based on the execution order of the first activity and the execution order of the second activity within the series of activities A1 to An.

FIG. 12 is a diagram depicting an execution order of the series of activities. In FIG. 12, the series of activities A1 to A8 identified from the process instance data 500 are graphically depicted. In the figure, digits encompassed by circles respectively representing the activities A1 to A8 indicate the execution order of each of the activities A1 to A8. The execution order of the activities A1 to A8 can be identified, for example, from the start time of each of the activities A1 to A8.

Here, the degree of relevancy between activities included in the series of activities is greater between activities whose execution order is relatively closer within the series of activities. Here, with consideration of the degree of relevancy between activities, a method of indirectly obtaining (from a weight indicative of the degree of relevancy between the name of the first activity and the business process Pj) the degree of relevancy between the name of the second activity and the business process Pj and will be described.

For example, the second calculator 607, based on an execution interval between the execution order of the first activity and the execution order of the second activity, calculates a weight indicative of the degree of relevancy between the name of the second activity and the business process Pj. Hereinafter, the execution interval between the execution order of the first activity and the execution order of the second activity will be referred to as the “distance between the first activity and the second activity”.

For example, the second calculator 607 uses equation (1) and calculates a weight indicative of the degree of relevancy between the name of the second activity and the business process Pj, where wa is a weight indicative of the degree of relevancy between the name of the first activity and the business process Pj, wb is a weight indicative of the degree of relevancy between the name of second activity and the business process Pj, X is a weighting coefficient, and D is the distance between the first activity and the second activity. “X̂D” represents “X raised to an exponent D”.

wb=wa×X̂D (1)

The weighting coefficient X is, for example, an arbitrary value greater than or equal to 0 and less than 1. Therefore, according to equation (1), the weight indicative of the degree of relevancy between the name of the second activity and the business process Pj decreases as the distance from the first activity increases.

Here, the weighting coefficient X is assumed to be “X=0.8” and the weight indicative of the degree of relevancy between the name “execution of transfer” of activity A6, which is the first activity and the business process of the name “transfer” is assumed to be “0.9” (see FIG. 8B). In this case, the weights indicative of the degrees of relevancy between the business process of the name “transfer” and the names of the activities A1 to A8 are as follows.

activity A1 (activity name: login)

0.9×0.8̂5=0.2

activity A2 (activity name: designation of sending account)

0.9×0.8̂4=0.3

activity A3 (activity name: setting of new recipient)

0.9×0.8̂3=0.4

activity A4 (activity name: designation of receiving account)

0.9×0.8̂2=0.5

activity A5 (activity name: designation of amount)

0.9×0.8̂1=0.7

activity A6 (activity name: execution of transfer)

0.9×0.8̂0=0.9

activity A7 (activity name: confirmation of execution results)

0.9×0.8̂1=0.7

activity A8 (activity name: logout)

0.9×0.8̂2=0.5

In the example above, for activity A6, which is the first activity, a weight indicative of the degree of relevancy between the activity name “execution of transfer” thereof and the business process of the name “transfer” is calculated. Further, in the example above, values are truncated to the first decimal place.

Each of the calculated weights indicative of the degrees of relevancy between the business process of the name “transfer” and the names of the activities A1 to A8 are, for example, stored to the weight table 1000 depicted in FIG. 10.

Next, a second example of the processing by the second calculator 607 will be described where a weight indicative of the degree of relevancy between the name of an activity Ai and the business process Pj is calculated based on an occurrence count for the business process Pj and an occurrence count for the activity Ai.

Here, the more frequently a given activity is included in a process instance correlated with the business process Pj, the greater the degree of relevancy is between the name of the given activity and the business process Pj. Here, with consideration of the frequency at which a given activity is included in a process instance correlated with the business process Pj, a method of calculating a weight indicative of the degree of relevancy between the name of the given activity and the business process Pj will be described.

For example, if the activities A1 to An and the business process Pj have been correlated, the second calculator 607 updates an occurrence count table 1300 depicted in FIG. 13. The occurrence count table 1300 is a table that correlates and stores an occurrence count for business process Pj and an occurrence count for activities related to business process Pj. The occurrence count table 1300 is implemented, for example, by a storage apparatus such as the RAM 303, the magnetic disk 305, and the optical disk 307. Here, the occurrence count table 1300 will be described.

FIGS. 13A, 13B, and 13C are diagrams depicting an example of the contents of the occurrence count table 1300. In FIG. 13A, the occurrence count table 1300 has fields for business process names, business process occurrence counts, activity names, and activity occurrence counts. By entering information into the fields, occurrence count data is stored.

Here, a business process name is the name of a business process Pj. A business process occurrence count is the occurrence count for the business process Pj. An activity name is the name of an activity Ai. An activity occurrence count is the occurrence count for the activity Ai. In an initial state, the fields in the occurrence count table 1300 are empty (no entry has been made).

As one example, a case is assumed where the activities A1 to A8 identified from the process instance data 500 and the business process of the name “transfer” have been correlated. In FIG. 13A, since the occurrence count table 1300 is in an initial state, the business process name “transfer” has not been registered.

Therefore, as depicted in FIG. 13B, the business process name “transfer” is registered into the occurrence count table 1300 by the second calculator 607. The names of the activities A1 to A8 are also registered into the occurrence count table 1300 by the second calculator 607.

In FIG. 13C, in the occurrence count table 1300, the occurrence count for the business process name “transfer” has been incremented by the second calculator 607. In the initial state, the occurrence count is “0”. Further, in the occurrence count table 1300, the occurrence counts for the activity names have been incremented by the second calculator 607.

The second calculator 607 refers to the occurrence count table 1300 and calculates weights indicative of the degrees of relevancy between the business process of the name “transfer” and the names of the activities A1 to A8.

For example, the second calculator 607 uses equation (2) and calculates a weight indicative of the degree of relevancy between the name of an activity Ai and the business process Pj, where, wi is a weight indicative of the degree of relevancy between the name of the activity Ai and the business process Pj, Ci is the occurrence count for the activity Ai, Cj is the occurrence count for the business process Pj, and Y is a weighting coefficient.

wi=Ci≧Cj×Y (2)

The weighting coefficient Y is, for example, an arbitrary value greater than or equal to 0 and less than 1. Here, the weighting coefficient Y is assumed to be “Y=0.5”. In this case, the weights that are indicative of the degree of relevancy between the business process of the name “transfer” and the names of the activities A1 to A8, and calculated by referring to the occurrence count table 1300 depicted in FIG. 13C are as follows.

activity A1 (activity name: login)

1÷1×0.5=0.5

activity A2 (activity name: designation of sending account)

1÷1×0.5=0.5

activity A3 (activity name: setting of new recipient)

1÷1×0.5=0.5

activity A4 (activity name: designation of receiving account)

1÷1×0.5=0.5

activity A5 (activity name: designation of amount)

1÷1×0.5=0.5

activity A6 (activity name: execution of transfer)

1÷1×0.5=0.5

activity A7 (activity name: confirmation of execution results)

1÷1×0.5=0.5

activity A8 (activity name: logout)

1÷1×0.5=0.5

In the example above, the values are truncated to the first decimal place. The calculated weights indicative of the degrees of relevancy between the business process of the name “transfer” and the names of the activities A1 to A8 are, for example, stored to the weight table 1000.

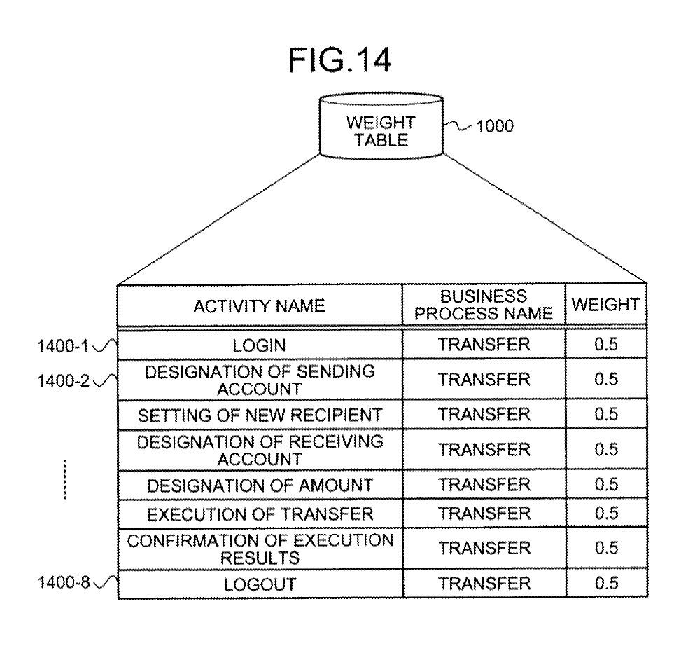

FIG. 14 is a diagram of a second example of the contents of the weight table 1000. In FIG. 14, the weight table 1000 stores weight data 1400-1 to 1400-8. Taking weight data 1400-1 as an example, the weight “0.5” indicative of the degree of relevancy between the activity name “login” and the business process of the name “transfer” is indicated.

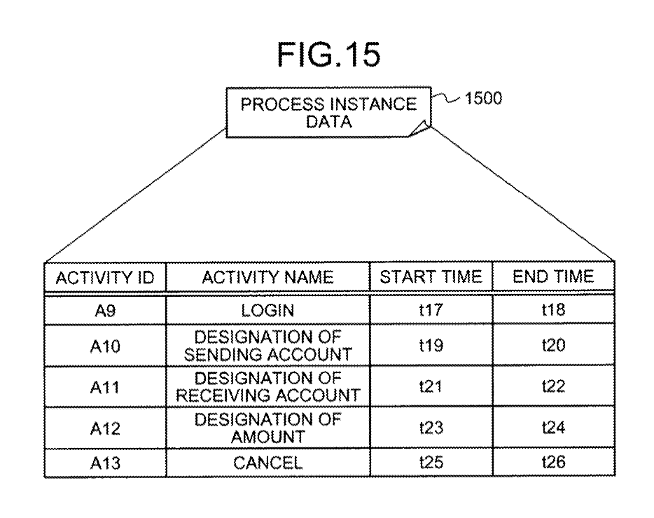

Processing of functional components subsequent to a second acquisition of process instance data will be described using process instance data 1500 depicted in FIG. 15 as an example.

FIG. 15 is a diagram of a second example of the process instance data. In FIG. 15, the process instance data 1500 is information for a series of activities A9 to A13 executed by the system 200. For example, the process instance data 1500 includes the activity ID, the activity name, the start time, and the end time of each activity A9 to A13.

For activity A9, the activity name “login”, the start time “t17”, and the end time “t18” are indicated. For activity A13, the activity name “cancel”, the start time “t25”, and the end time “t26” are indicated.

FIGS. 16A and 16B are diagrams of a third example of the contents of the business process pattern table 700. In FIG. 16A, activity names identified from the process instance data 1500 are registered in the business process pattern table 700.

The detector 602, from among the activities A9 to A13 in the business process pattern table 700 depicted in FIG. 16, detects a first activity whose name matches a keyword K stored in the keyword table 220. Here, since no activity whose name matches a keyword K is present, no first activity is detected.

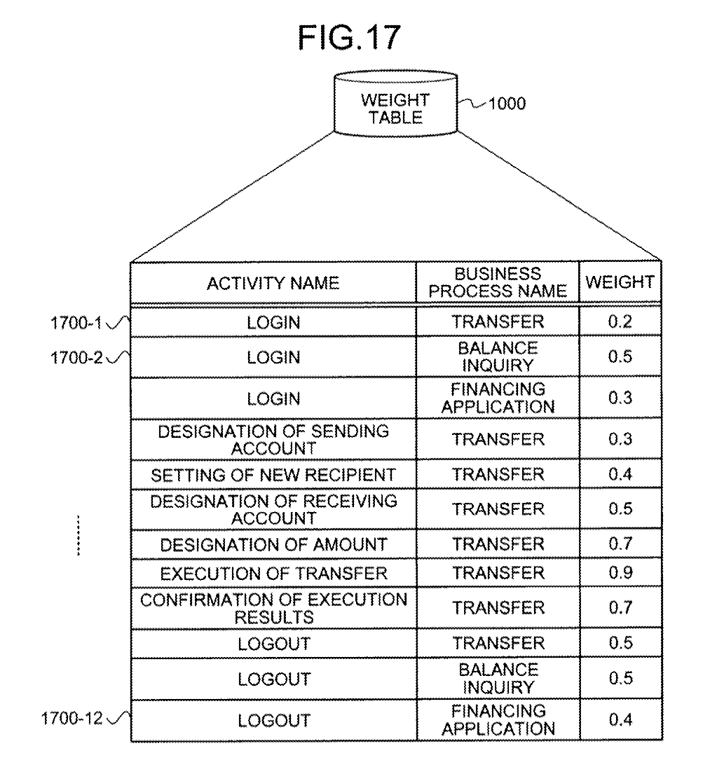

The updater 608 refers to the weight table 1000 and updates the contents of the business process pattern table 700. Here, as one example, description will be given for a case where the weight table 1000 depicted in FIG. 17 is referred to.

FIG. 17 is a diagram depicting a third example of the contents of the weight table 1000. In FIG. 17, the weight table 1000 stores weight data 1700-1 to 1700-12. For example, for weight data 1700-1, the weight “0.2” indicative of the degree of relevancy between the activity name “login” and the business process of the name “transfer” is indicated.

For example, the updater 608 extracts from the weight table 1000 depicted in FIG. 17, weights for the business processes of the activities A9 to A13 and updates the contents of the business process pattern table 700.

In FIG. 16B, the contents of the business process pattern table 700 have been updated. For example, the business process name “transfer” is registered, and weights indicative of the degrees of relevancy between the business process of the name “transfer” and the names of the activities A9 to A13 have also been registered.

Further, the business process name “balance inquiry” has been registered together with weights indicative of the degrees of relevancy between the business process of the name “balance inquiry” and the names of the activities A9 to A13. The business process name “financing application” has been registered together with weights indicative of the degrees of relevancy between the business process of the name “financing application” and the names of the activities A9 to A13.

The first calculator 604 refers to the business process pattern table 700 and calculates a level of association Vj indicative of the degree of relevancy between the activities A9 to A13 and a business process Pj. The correlator 605, based on the calculated level of association Vj, correlates the activities A9 to A13 and the business process Pj. Here, a case where the activities A9 to A13 and the business process of the name “transfer” have been correlated is assumed.

The second calculator 607 calculates weights indicative of the degrees of relevancy between the business process of the name “transfer” and the names of the activities A9 to A13. Hereinafter, processing by the second calculator 607 will be described.

A case will be described where weights indicative of the degrees of relevancy between the business process of the name “transfer” and the names of the activities A9 to A13 are calculated by the first example of processing by the second calculator 607, described above.

Here, each activity Ai among the activities A9 to A13 is regarded as the first activity and a weight indicative of the degree of relevancy between the name of the activity Ai and the business process of the name “transfer” is calculated based on the execution order of the activities. Here, the weighting coefficient X included in equation (1) is assumed to be “X=0.8”.

In this case, weights calculated with respect to the activities A9 to A13 and indicative of the degrees of relevancy with the business process of the name “transfer” are as follows.

activity A9 (activity name: login)

0.2×0.8̂0=0.2 (first activity:A9)

0.3×0.8̂1=0.2 (first activity:A10)

0.5×0.8̂2=0.3 (first activity:A11)

0.7×0.8̂3=0.3 (first activity:A12)

0×0.8̂4=0 (first activity:A13)

activity A10 (activity name: designation of sending account)

0.2×0.8̂1=0.1 (first activity:A9)

0.3×0.8̂0=0.3 (first activity:A10)

0.5×0.8̂1=0.4 (first activity:A11)

0.7×0.8̂2=0.4 (first activity:A12)

0×0.8̂3=0 (first activity:A13)

activity A11 (activity name: designation of receiving account)

0.2×0.8̂2=0.1 (first activity:A9)

0.3×0.8̂1=0.2 (first activity:A10)

0.5×0.8̂0=0.5 (first activity:A11)

0.7×0.8̂1=0.5 (first activity:A12)

0×0.8̂2=0 (first activity:A13)

activity A12 (activity name: designation of amount)

0.2×0.8̂3=0.1 (first activity:A9)

0.3×0.8̂2=0.1 (first activity:A10)

0.5×0.8̂1=0.4 (first activity:A11)

0.7×0.8̂0=0.7 (first activity:A12)

0×0.8̂1=0 (first activity:A13)

activity A13 (activity name: cancel)

0.2×0.8̂4=0.0 (first activity:A9)

0.3×0.8̂3=0.1 (first activity:A10)

0.5×0.8̂2=0.3 (first activity:A11)

0.7×0.8̂1=0.5 (first activity:A12)

0×0.8̂0=0 (first activity:A13)

The second calculator 607, based on the calculation results for each activity Ai taken as the first activity, calculates a weight indicative of the degree of relevancy between the name of each activity Ai and the business process of the name “transfer”.

For example, the second calculator 607 assumes the largest value among the calculated values for an activity Ai to be the weight indicative of the degree of relevancy between the name of the activity Ai and the business process of the name “transfer”. For the example of activity A9 above, the weight indicative of the degree of relevancy between the name of activity A9 and the business process of the name “transfer” is “0.3”.

The second calculator 607 may assume an average of the calculated weights to be the weight indicative of the degree of relevancy between the name of the activity Ai and the business process of the name “transfer”. For the example of activity A9 above, the weight indicative of the degree of relevancy between the name of activity A9 and the business process of the name “transfer” is “0.2”.

The calculated weights indicative of the degrees of relevancy between the business process of the name “transfer” and the names of the activities A9 to A13 are, for example, stored to the weight table 1000 depicted in FIG. 17. Here, an example of updating of the weight table 1000 will be described.

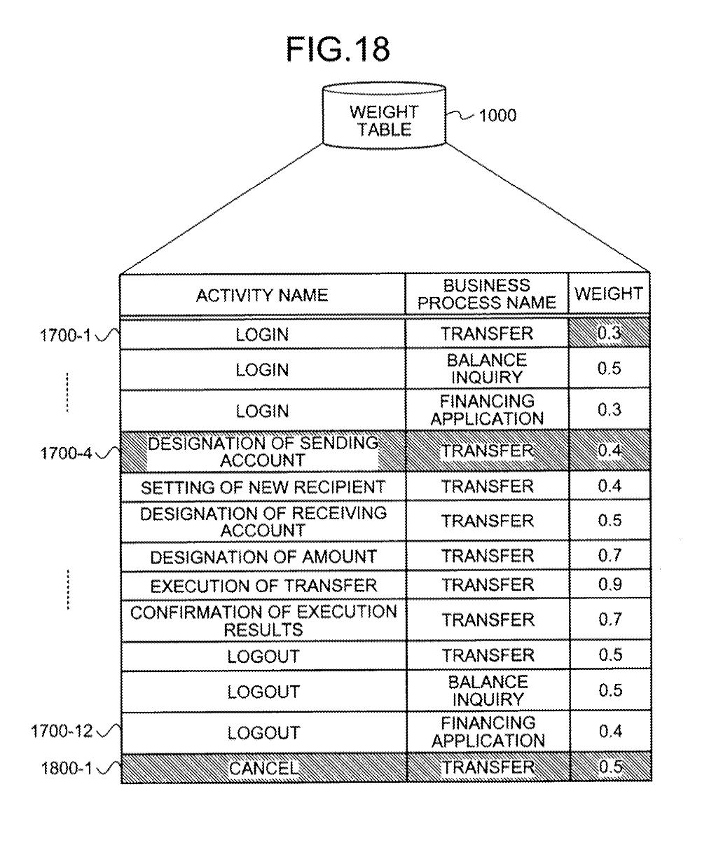

FIG. 18 is a diagram depicting a first example of updating of the weight table 1000. In FIG. 18, the weight indicated by weight data 1700-1 in the weight table 1000 has been updated from “0.2” (see FIG. 17) to “0.3”. Further, the weight indicated by weight data 1700-4 has been updated from “0.3” (see FIG. 17) to “0.4” and weight data 1800-1 has been newly added.

A case will be described where weights indicative of the degrees of relevancy between the business process of the name “transfer” and the name of each activity Ai in the weight table 1000 depicted in FIG. 14 are calculated by the second example of processing by the second calculator 607, described above.

For example, the second calculator 607 updates the occurrence count table 1300 depicted in FIG. 13 to indicate that the activities A9 to A13 identified from the process instance data 1500 and the business process of the name “transfer” have been correlated.

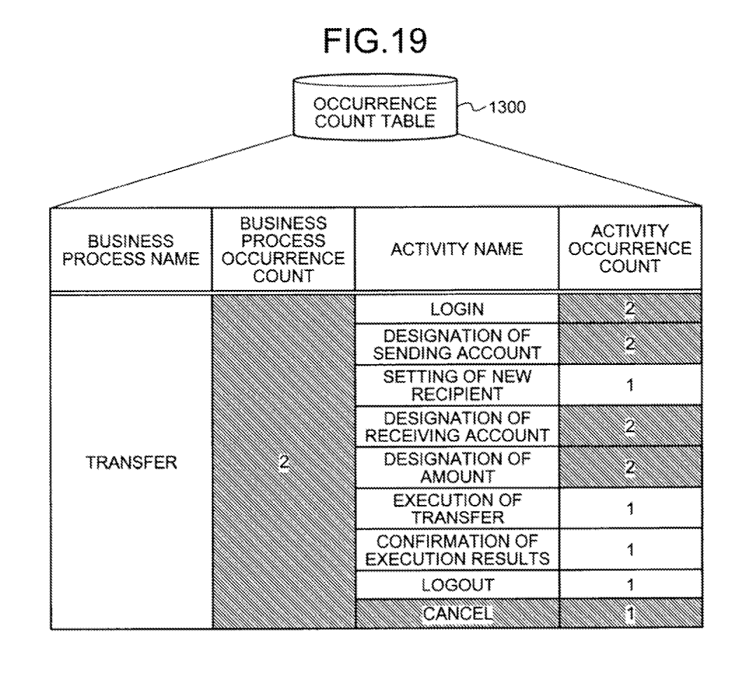

FIG. 19 is a diagram depicting an example of updating of the occurrence count table 1300. In FIG. 19, the occurrence count for the business process name “transfer” in the occurrence count table 1300 has been incremented. The occurrence counts for the activity names “login”, “designation of sending account”, “designation of receiving account”, and “designation of amount” in the occurrence count table 1300 have been incremented. Further, the activity name “cancel” has been registered and the occurrence count for the activity name “cancel” has been incremented.

The second calculator 607 refers to the occurrence count table 1300 depicted in FIG. 19 and calculates weights indicating the degrees of relevancy between the business process of the name “transfer” and each of the activity names in the occurrence count table 1300. Here, the weighting coefficient Y included in equation (2) is assumed to be “Y=0.5”.

In this case, the weights calculated by referring to the occurrence count table 1300 depicted in FIG. 19 and indicative of the degrees of relevancy between the business process of the name “transfer” and each of the activity names are as follows.

activity name: login

2÷2×0.5=0.5

activity name: designation of sending account

2÷2×0.5=0.5

activity name: setting of new recipient

1÷2×0.5=0.2

activity name: designation of receiving account

2÷2×0.5=0.5

activity name: designation of amount

2÷2×0.5=0.5

activity name: execution of transfer

1÷2×0.5=0.2

activity name: confirmation of execution results

1÷2×0.5=0.2

activity name: logout

1÷2×0.5=0.2

activity name: cancel

1÷2×0.5=0.2

The calculated weights indicative of degrees of relevancy between the business process of the name “transfer” and the activity names in the occurrence count table 1300 are, for example, stored to the weight table 1000 depicted in FIG. 14. Here, an example of updating of the weight table 1000 will be described.

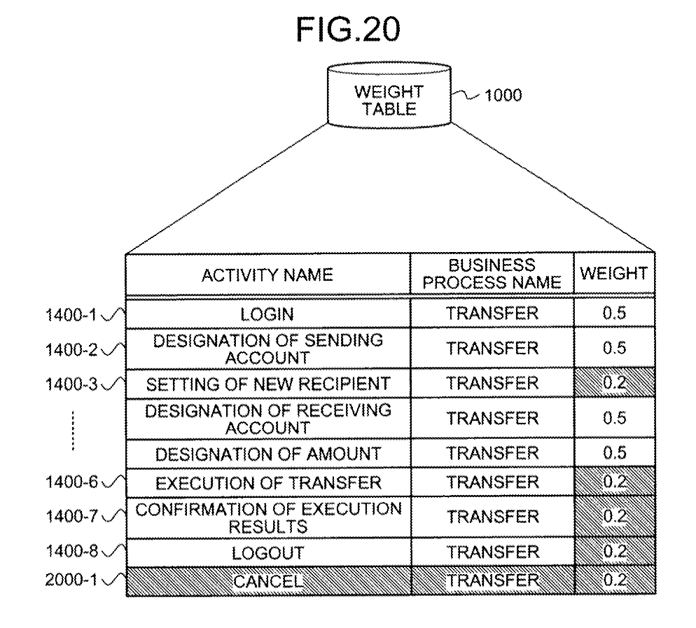

FIG. 20 is a diagram depicting a second example of updating of the weight table 1000. In FIG. 20, the weight indicated by weight data 1400-3 in the weight table 1000 has been updated from “0.5” (see FIG. 14) to “0.2”. Further, the weights indicated by weight data 1400-6 to 1400-8 have been updated from “0.5” (see FIG. 14) to “0.2” and weight data 2000-1 has been newly registered.

Processing by the first calculator 604 will be described. Here, a first example of processing by the first calculator 604 will be described where a level of association Vj indicative of the degree of relevancy between the business process Pj and the activities A1 to An is calculated based on the contents of the business process pattern table 700 depicted in FIG. 16B.

The first calculator 604 calculates a level of association Vj indicative of the degree of relevancy between the business process Pj and the activities A1 to An by adding the weights indicative of the degrees of relevancy between the business process Pj and each of the activity names in the business process pattern table 700.

The first calculator 604 adds the weights indicative of the degrees of relevancy between the business process of the name “transfer” and each of the activity names in the business process pattern table 700. Here, the sum of the weights is “1.7”. Therefore, the level of association indicative of the degrees of relevancy between the business process of the name “transfer” and the activities A9 to A13 is “1.7”.

The first calculator 604 adds the weights indicative of the degrees of relevancy between the business process of the name “balance inquiry” and each of the activity names in the business process pattern table 700. Here, the sum of the weights is “0.5”. Therefore, the level of association indicative of the degrees of relevancy between the business process of the name “balance inquiry” and the activities A9 to A13 is “0.5”.

The first calculator 604 adds the weights indicative of the degrees of relevancy between the business process of the name “financing application” and each of the activity names in the business process pattern table 700. Here, the sum of the weights is “0.3”. Therefore, the level of association indicative of the degrees of relevancy between the business process of the name “financing application” and the activities A9 to A13 is “0.3”.

The correlator 605 correlates the business process Pj having the greatest level of association among the business processes P1 to Pm with the activities A1 to An. In the example described above, since the level of association “1.7” for the business process of the name “transfer” is greatest, the correlator 605 correlates the activities A1 to An and the business process of the name “transfer”.

A second example of processing by the first calculator 604 will be described. The first calculator 604 calculates a level of association Vj concerning the activities A1 to An by counting for the business process Pj, the number of weights thereof that for the same activity name, are the largest among the business processes P1 to Pm (the weight being indicative of the degrees of relevancy with each activity name in the business process pattern table 700).

For the business process of the name “transfer”, the first calculator 604 counts the number of weights thereof that for the same activity name, are the largest among the business processes. In this example, the business process of the name “transfer” has the largest weights for the activity names “designation of sending account”, “designation of receiving account”, and “designation of amount”, among the 3 processes. Therefore, the level of association indicative of the degree of relevancy between the business process of the name “transfer” and the activities A9 to A13 is “3”.

For the business process of the name “balance inquiry”, the first calculator 604 counts the number of weights thereof that for the same activity name, are the largest among the business processes. In this example, the business process of the name “balance inquiry” has the largest weights for the activity name “login”, among the 3 processes. Therefore, the level of association indicative of the degree of relevancy between the business process of the name “balance inquiry” and the activities A9 to A13 is “1”.

For the business process of the name “financing application” the first calculator 604 counts the number of weights thereof that for the same activity name, are the largest among the business processes. In this example, the business process of the name “financing application” has no weights (“0”) that are the largest for any activity name. Therefore, the level of association indicative of the degree of relevancy between the business process of the name “financing application” and the activities A9 to A13 is “0”.

A third example of processing by the first calculator 604 will be described. Here, activity names such as “login” and “logout” are general activities used by a large number of business processes. In other words, general activity names have a low degree of relevancy with a business process Pj compared to non-general activity names.

Hereinafter, a method of correcting a weight indicative of the degree of relevancy between a general activity name and a business process Pj will be described. The first calculator 604 corrects a weight indicative of the degree of relevancy between the name of an activity Ai and the business process Pj, based on the number of business processes having a weight indicative of the degree of relevancy with the name of the activity Ai.

In other words, the first calculator 604 corrects the weight indicative of the degree of relevancy between the name of the activity Ai and the business process Pj, based on the number of business processes related to the activity Ai. For example, in the example of the weight table 1000 depicted in FIG. 18, the number of business processes related to the activity of the name “login” is “3” (i.e., transfer, balance inquiry, financing application).

For example, the first calculator 604 uses equation (3) and corrects the weights indicative of the degrees of relevancy between a business process Pj and each activity name in the business process pattern table 700, where wi is a weight indicative of the degree of relevancy between the name of an activity Ai and the business process Pj, Z is a general coefficient, and N is the number of business processes related to the activity Ai.

wi=wi×ẐN (3)

The general coefficient Z is, for example, an arbitrary value greater than 0 and less than 1. Thus, according to equation (3), the greater the number of business processes N related to activity Ai is, the smaller the weight wi indicative of the degree of relevancy between the name of the activity Ai and the business process Pj is.

When the weight wi indicative of the degree of relevancy between the name of the activity Ai and the business process Pj is corrected, for example, the level of association Vj between the activities A1 to An and business process Pj is calculated based on the corrected weight wi. In this case, the level of association Vj between the activities A1 to An and the business process Pj may be calculated by the first example or the second example of processing by the first calculator 604 described above.

The procedure of the analysis support processing by the analysis support apparatus 100 according to the second embodiment will be described.

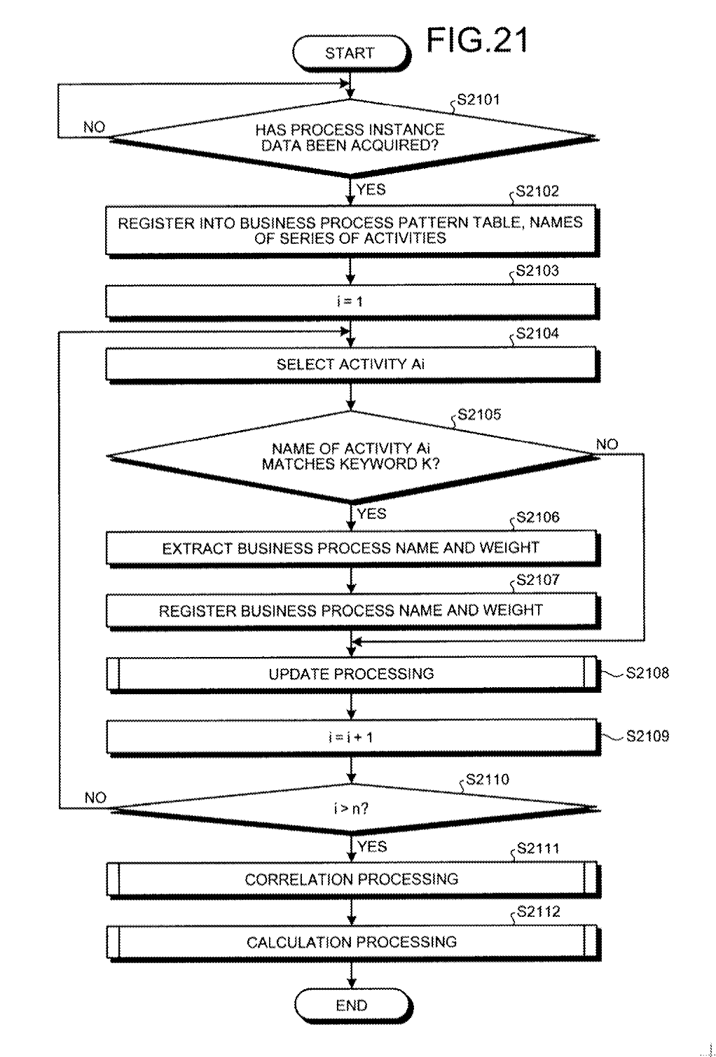

FIG. 21 is a flowchart of an example of the procedure of the analysis support processing by the analysis support apparatus 100. In the flowchart depicted in FIG. 21, the acquirer 601 determines whether process instance data indicative of a series of activities A1 to An that have been executed by the system 200 has been acquired (step S2101).

Here, the analysis support apparatus 100 remains in standby until the acquirer 601 acquires process instance data (step S2101: NO). When the acquirer 601 has acquired process instance data (step S2101: YES), the analysis support apparatus 100 registers into the business process pattern table 700, the names of the activities A1 to An identified from the process instance data (step S2102).

The detector 602 sets “i” of activity Ai to be “i=1” (step S2103), and selects the activity Ai from among the activities A1 to An (step S2104). The detector 602 determines whether the name of the selected activity Ai matches a keyword K registered in the keyword table 220 (step S2105).

Here, if the name does not match a keyword K (step S2105: NO), the flow transitions to step S2108. On the other hand, if the name matches a keyword K (step S2105: YES), the extractor 603 extracts from the keyword table 220, the business process name that corresponds to the keyword K that the name matches and a weight (step S2106).

The extractor 603 registers the extracted business process name and weight into the business process pattern table 700 (step S2107). The updater 608 executes update processing to update the contents of the business process pattern table 700 (step S2108).

The detector 602 increments “i” of the activity Ai (step S2109), and determines whether “i” is greater than “n” (step S2110). If “i” is less than or equal to “n” (step S2110: NO), the flow returns to step S2104.

On the other hand, if “i” is greater than “n” (step S2110: YES), the correlator 605 executes correlation processing to correlate the activities A1 to An and the business process Pj (step S2111). The second calculator 607 executes calculation processing to calculate a weight indicative of the degree of relevancy between the name of the activity Ai and the business process Pj (step S2112), thereby ending the processing according to the flowchart.

Thus, even if a series of activities does not include an activity name that matches a preliminarily prepared keyword K, correlation of the activities A1 to An and the business process Pj can be performed using weight data accumulated in the weight table 1000.

The update processing at step S2108 depicted in FIG. 21 will be described.

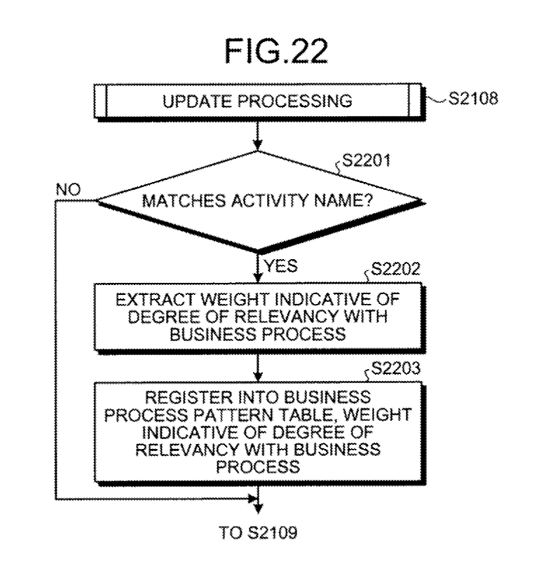

FIG. 22 is a flowchart of an example of the update processing. In the flowchart depicted in FIG. 22, the updater 608 determines whether the name of an activity Ai matches an activity name stored in the weight table 1000 (step S2201).

If the name does not match a stored activity name (step S2201: NO), the flow transitions to step S2109 depicted in FIG. 21. On the other hand, if the name matches a stored activity name (step S2201: YES), the updater 608 extracts from the weight table 1000, a weight indicative of the degree of relevancy with the business process corresponding to the matching activity name (step S2202).

The updater 608 registers into the business process pattern table 700, the extracted weight as a weight indicative of the degree of relevancy between the name of the activity Ai and the business process (step S2203), and the flow transitions to step S2109 depicted in FIG. 21.

Thus, a weight indicative of the degree of relevancy between the name of the activity Ai and the business process, registered in the weight table 1000 can be reflected to the business process pattern table 700.

The correlation processing at step S2111 depicted in FIG. 21 will be described.

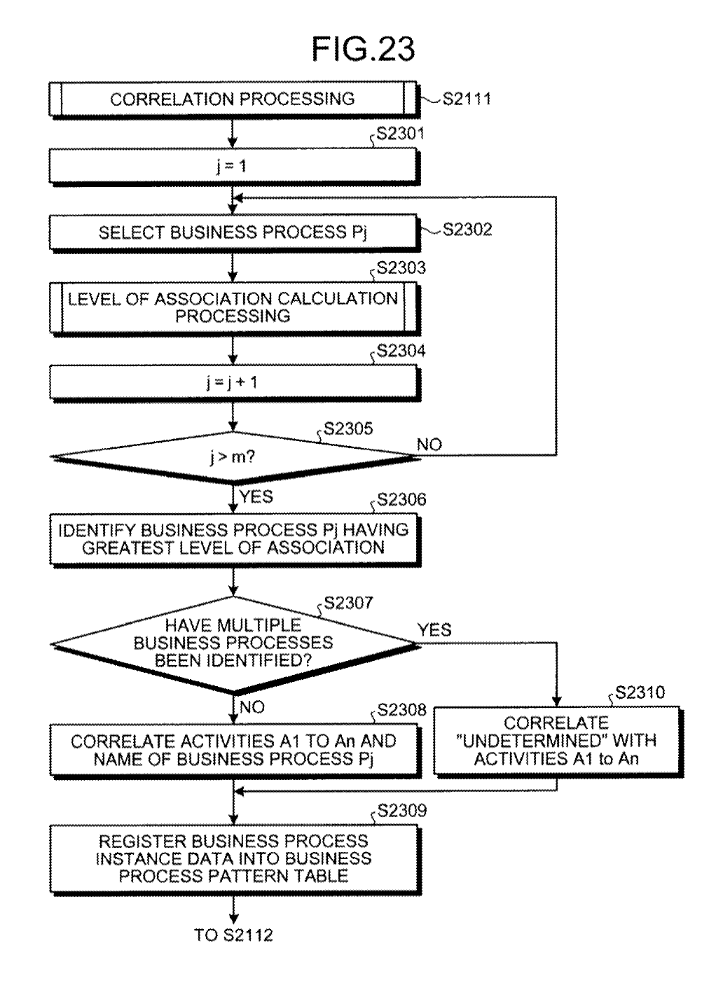

FIG. 23 is a flowchart of an example of the correlation processing. In the flowchart depicted in FIG. 23, the first calculator 604 sets “j” of business process Pj to be “j=1” (step S2301), The first calculator 604 selects the business process Pj from among the business processes P1 to Pm in the business process pattern table 700 (step S2302).

The first calculator 604 executes level of association calculation processing to calculate a level of association Vj indicative of the degree of relevancy between the business process Pj and the activities A1 to An (step S2303). The first calculator 604 increments “j” of business process Pj (step S2304), and determines whether “j” is greater than “m” (step S2305).

If “j” is less than or equal to “m” (step S2305: NO), the flow returns to step S2302. On the other hand, if “j” is greater than “m” (step S2305: YES), the correlator 605 identifies the business process Pj having the greatest level of association among the business processes P1 to Pm (step S2306).

The correlator 605 determines whether multiple business processes having the greatest level of association have been identified (step S2307). If 1 business process Pj has been identified (step S2307: NO), the correlator 605 correlates the activities A1 to An and the name of the business process Pj (step S2308).

The output unit 606 registers into the business process instance DB 900, business process instance data indicative of the resulting correspondence (step S2309), and the flow transitions to step S2112 depicted in FIG. 21.

At step S2307, if multiple business processes have been identified (step S2307: YES), the correlator 605 correlates “undetermined” with the activities A1 to An (step S2310), and the flow transitions to step S2309.

Thus, among the business processes P1 to Pm in the business process pattern table 700, the business process Pj having the greatest level of association with the activities A1 to An can be correlated with the activities A1 to An.

At step S2307, if multiple business processes are identified (step S2307: YES), the correlator 605 may correlate the activities A1 to An and the name of any one of the identified business processes Pj.

The level of association calculation processing at step S2303 depicted in FIG. 23 will be described.

A first level of association calculation processing corresponding to the first example of processing by the first calculator 604 above will be described. Here, weights indicative of the degrees of relevancy between the business process Pj and the name of each of the activities A1 to An in the business process pattern table 700 are indicated as “weights w1 to wn”.

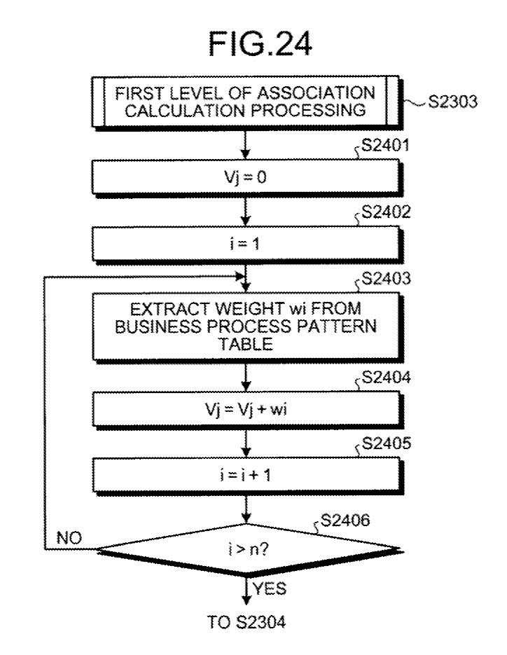

FIG. 24 is a flowchart of an example of the first level of association calculation processing/correlation processing. In the flowchart depicted in FIG. 24, the first calculator 604 initializes the level of association Vj indicative of the degree of relevancy between a business process Pj and the activities A1 to An to be “Vj=0” (step S2401).

The first calculator 604 sets “i” of activity Ai to be “i=1” (step S2402). The first calculator 604 extracts from the business process pattern table 700, a weight wi indicative of the degree of relevancy between the name of the activity Ai and the business process Pj (step S2403).

The first calculator 604 sets the level of association Vj indicative of the degree of relevancy between the business process Pj and the activities A1 to An to be “Vj=Vj+wi” (step S2404). The first calculator 604 increments “i” of the activity Ai (step S2405), and determines whether “i” is greater than “n” (step S2406).

If “i” is less than or equal to “n” (step S2406: NO), the flow returns to step S2403. If “i” is greater than “n” (step S2406: YES), the flow transitions to step S2304 depicted in FIG. 23.

Thus, weights wi indicative of the degree of relevancy between a business process Pj and the name of each activity Ai are calculated and a level of association Vj indicative of the degree of relevancy between the business process Pj and the activities A1 to An can be calculated.

A second level of association calculation processing corresponding to the second example of processing by the first calculator 604 above will be described.

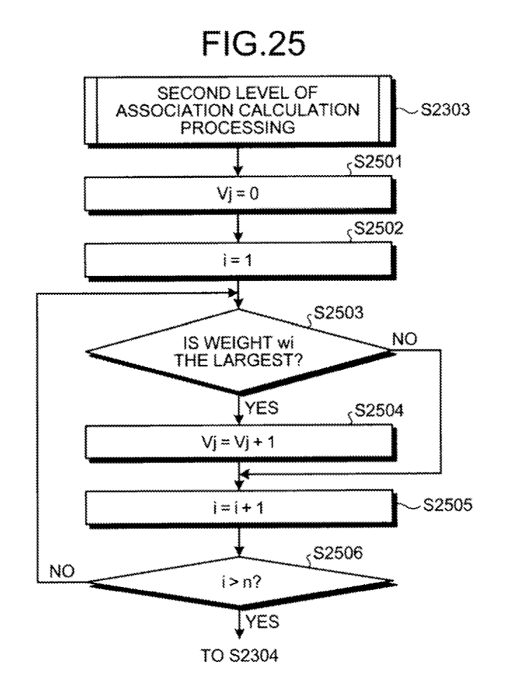

FIG. 25 is a flowchart of an example of the second level of association calculation processing/correlation processing. In the flowchart depicted in FIG. 25, the first calculator 604 initializes the level of association Vj indicative of the degree of relevancy between the business process Pj and the activities A1 to An to be “Vj=0” (step S2501).

The first calculator 604 sets “i” of activity Ai to be “i=1” (step S2502). The first calculator 604 refers to the business process pattern table 700 and determines whether the weight wi indicative of the degree of relevancy between the name of the activity Ai and the business process Pj is the largest among the weights for the business processes P1 to Pm with respect to the same activity name (step S2503).

If the weight wi is not the largest (step S2503: NO), the flow transitions to step S2505. On the other hand, if the weight wi is the largest (step S2503: YES), the first calculator 604 sets the level of association Vj indicative of the degree of relevancy between the business process Pj and the activities A1 to An to be “Vj=Vj+1” (step S2504).

The first calculator 604 increments “i” of the activity Ai (step S2505), and determines whether “i” is greater than “n” (step S2506). If “i” is less than or equal to “n” (step S2506: NO), the flow returns to step S2503. On the other hand, if “i” is greater than “n” (step S2506: YES), the flow transitions to step S2304 depicted in FIG. 23.

Thus, the level of association Vj indicative of the degree of relevancy between the business process Pj and the activities A1 to An can be calculated based on the number of activities Ai for which the business process Pj has the largest weights wi among the business processes P1 to P.

A third level of association calculation processing corresponding to the third example of processing by the first calculator 604 above.

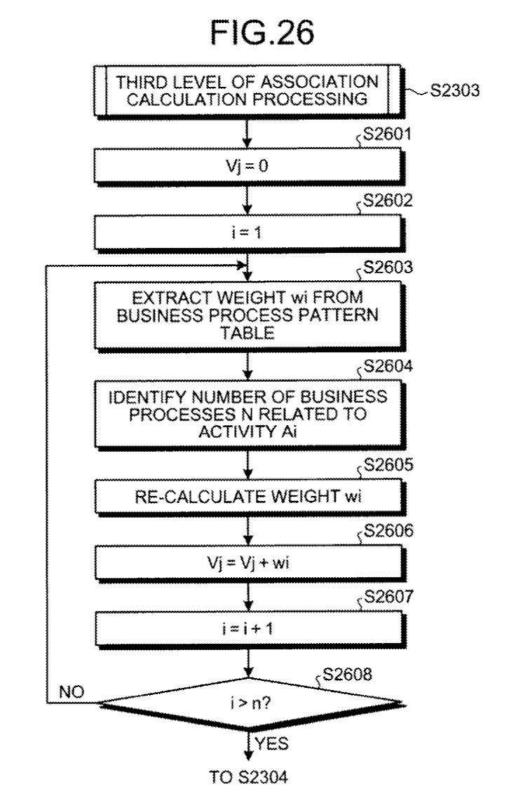

FIG. 26 is a flowchart of an example of the third level of association calculation processing/correlation processing. In the flowchart depicted in FIG. 26, the first calculator 604 initializes the level of association Vj indicative of the degree of relevancy between the business process Pj and the activities A1 to An, to be “Vj=0” (step S2601).

The first calculator 604 sets “i” of activity Ai to be “i=1” (step S2602). The first calculator 604 extracts from the business process pattern table, a weight wi indicative of the degree of relevancy between the business process Pj and the name of the activity Ai (step S2603).

The first calculator 604 refers to the weight table 1000, and identifies the number of business processes N related to the activity Ai (step S2604). The first calculator 604 uses equation (3) and re-calculates the weight wi indicative of the degree of relevancy between the business process Pj and the name of the activity Ai (step S2605).

The first calculator 604 sets the level of association Vj indicative of the degree of relevancy between the business process Pj and the activities A1 to An to be “Vj=Vj+wi” (step S2606). The first calculator 604 increments “i” of the activity Ai (step S2607), and determines whether “i” is greater than “n” (step S2608).

If “i” is less than or equal to “n” (step S2608: NO), the flow returns to step S2603. On the other hand, if “i” is greater than “n” (step S2608: YES), the analysis support apparatus 100 transitions to step S2304 depicted in FIG. 23.

Thus, a weight indicative of the degree of relevancy between a general activity and the business process Pj can be estimated to be of a low value, from which the level of association Vj indicative of the degree of relevancy between the business process Pj and the activities A1 to An can be calculated.

The weight calculation processing at step S2112 depicted in FIG. 21 will be described. A first weight calculation processing corresponding to the first example of processing by the second calculator 607 will be described.

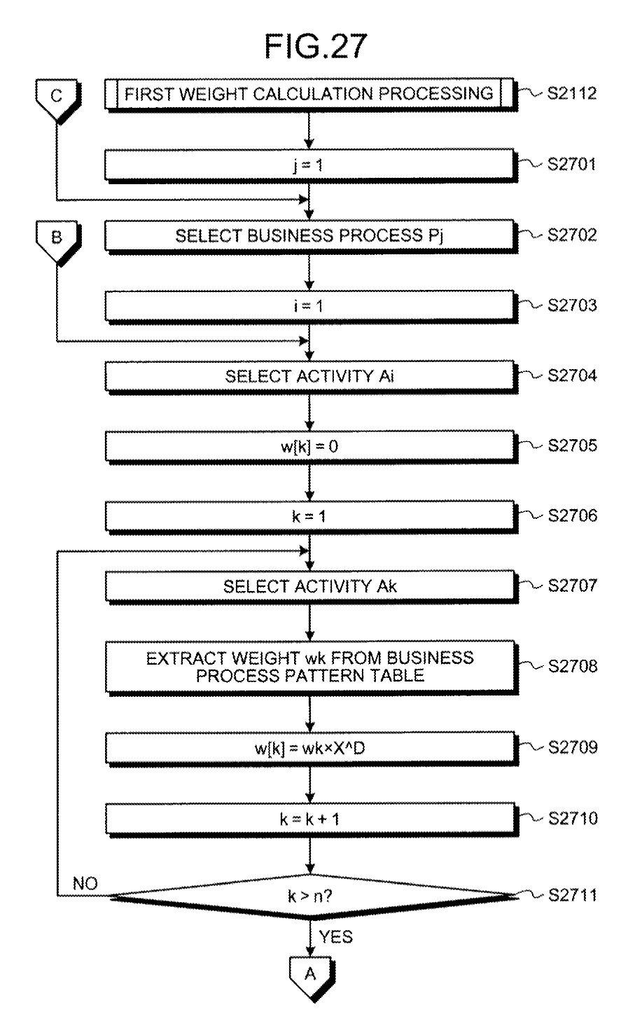

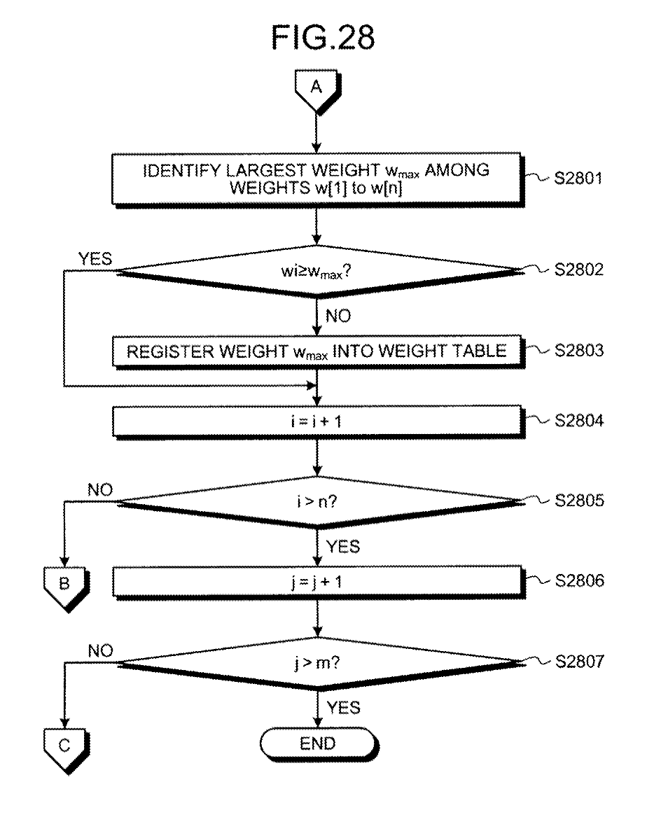

FIGS. 27 and 28 are flowcharts of an example of the first weight calculation processing. In the flowchart depicted in FIG. 27, the second calculator 607 sets “j” of business process Pj to be “j=1” (step S2701). The second calculator 607 selects the business process Pj from among the business processes P1 to Pm (step S2702).

The second calculator 607 sets “i” of activity Ai to be “i=1” (step S2703), and selects the activity Ai from among the activities A1 to An (step S2704). The second calculator 607 sets the weight w[k] indicative of the degree of relevancy between the name of the activity Ai and the business process Pj to be “w[k]=0” (step S2705).

The second calculator 607 sets “k” of activity Ak to be “k=1” (step S2706), and selects the activity Ak from among the activities A1 to An (step S2707). The second calculator 607 extracts from the business process pattern table 700, the weight wk indicative of the degree of relevancy between the name of the activity Ak and the business process Pj (step S2708).

The second calculator 607 uses equation (4) and calculates the weight w[k] indicative of the degree of relevancy between the name of the activity Ai and the business process Pj (step S2709).

w[k]=wk×X̂D (4)

The second calculator 607 increments “k” of the activity Ak (step S2710), and determines whether “k” of the activity Ak is greater than “n” (step S2711). If “k” is less than or equal to “n” (step S2711: NO), the flow returns to step S2707. On the other hand, if “k” is greater than “n” (step S2711: YES), the flow transitions to step S2801 depicted in FIG. 28.

In the flowchart depicted in FIG. 28, the second calculator 607 identifies the largest weight wₘₐₓ among the weights w[1] to w[n] (step S2801). The second calculator 607 determines whether the weight wi in the weight table 1000 and indicative of the degree of relevancy between the name of the activity Ai and the business process Pj is at least equal to the weight wₘₐₓ (step S2802).

If the weight wi is greater than or equal to the weight wₘₐₓ (step S2802: YES), the flow transitions to step S2804. On the other hand, if the weight wi is less than the weight wₘₐₓ (step S2802: NO), the second calculator 607 registers into the weight table 1000, the weight wₘₐₓ as the weight wi (step S2803).

The second calculator 607 increments “i” of the activity Ai (step S2804), and determines whether “i” is greater than “n” (step S2805). If “i” is less than or equal to “n” (step S2805: NO), the flow transitions to step S2704 depicted in FIG. 27.

If “i” is greater than “n” (step S2805: YES), the second calculator 607 increments “j” of the business process Pj (step S2806), and determines whether “j” is greater than “m” (step S2807).

If “j” is less than or equal to “m” (step S2807: NO), the flow transitions to step S2702 depicted in FIG. 27. On the other hand, if “j” is greater than “m” (step S2807: YES), the processing according to the flowchart ends.

Thus, by distributing the weights w[k] of the activities Ak to other activities based on execution intervals between activities in the series of activities A1 to An, weights wi indicative of the degree of relevancy between the business process Pj and the names of the activities Ai can be calculated.

A second weight calculation processing corresponding to the second example of processing by the second calculator 607 will be described.

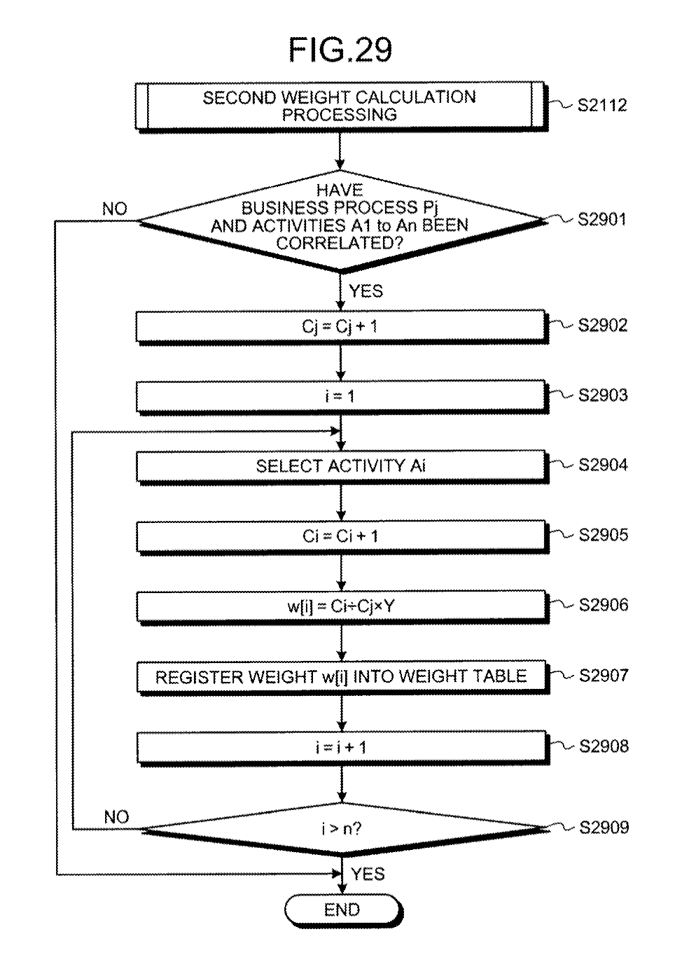

FIG. 29 is a flowchart of an example of the second weight calculation processing. In the flowchart depicted in FIG. 29, the second calculator 607 determines whether the business process Pj and the activities A1 to An have been correlated (step S2901).

If the business process Pj and the activities A1 to An have been correlated (step S2901: YES), the second calculator 607 increments the occurrence count Cj for the business process Pj in the occurrence count table 1300 (step S2902).

The second calculator 607 sets “i” of activity Ai to be “i=1” (step S2903), and selects the activity Ai from among the activities A1 to An (step S2904). The second calculator 607 increments the occurrence count Ci for the activity Ai in the occurrence count table 1300 (step S2905).

The second calculator 607 uses equation (5) and calculates a weight w[i] indicative of the degree of relevancy between the name of the activity Ai and the business process Pj (step S2906).

w[i]=Ci÷Cj×Y (5)

The second calculator 607 registers into the weight table 1000, the weight w[i] as the weight wi (step S2907).

The second calculator 607 increments “i” of the activity Ai (step S2908), and determines whether “i” is greater than “n” (step S2909). If “i” is less than or equal to “n” (step S2909: NO), the flow returns to step S2904.

On the other hand, if “i” is greater than “n” (step S2909: YES), the processing according to the flowchart ends. Further, at step S2901, if the business process Pj and the activities A1 to An have not been correlated (step S2901: NO), the processing according to the flowchart ends.

Thus, based on the frequency at which a given activity is included in a process instance correlated with the business process Pj, a weight wi indicative of the degree of relevancy between the name of the activity Ai and the business process Pj can be calculated.

Generation processing for the keyword table 220 performed by the analysis support apparatus 100 will be described. Here, a Japanese translation dictionary is assumed for operations of each type of business field. A word dictionary is further assumed for the operations of each type of business field.

FIG. 30 is a flowchart of an example of generation processing for the keyword table 220. In the flowchart depicted in FIG. 30, the analysis support apparatus 100 selects a business process to analyzed (step S3001).

The analysis support apparatus 100 decomposes the name of the selected business process into words (step S3002), and registers the words into the keyword table 220 (step S3003). Here, the business process name and a preliminarily set weight (e.g., 0.8) are correlated with the words and registered.

The analysis support apparatus 100 registers into the keyword table 220, a character string that is a word among the words, to which an action word (e.g., execution, startup) has been added (step S3004). Here, the business process name and a preliminarily set weight (e.g., 0.9) are correlated with the character string and registered.

The analysis support apparatus 100 registers into the keyword table 220, a character string that is a Japanese translation of a word among the words (step S3005). Here, the business process name and a preliminarily set weight (e.g., 0.8) is correlated with the character string and registered.

The analysis support apparatus 100 registers into the keyword table 220 a character string that is a Japanese translation of a word among the words, to which an action word has been added (step S3006). Here, the business process name and a preliminarily set weight (e.g., 0.9) is correlated with the character string and registered.

The analysis support apparatus 100 registers into the keyword table 220, a character string that represents a Japanese translation in the English alphabet (step S3007). Here, the business process name and a preliminarily set weight (e.g., 0.8) is correlated with the character string and registered.

The analysis support apparatus 100 determines whether a business process that has yet to be selected remains among the business processes to be subject to analysis (step S3008). If an unselected business process is present (step S3008: YES), the flow returns to step S3001. On the other hand, if no unselected business process is present (step S3008: NO), the processing according to the flowchart ends.

Thus, the keyword table 220 that stores keywords related to a business process under analysis can be generated.

Although description has been given for a case where the analysis support apparatus 100 automatically generates the keyword table 220, the keyword table 220 may be generated by user input to the analysis support apparatus 100. Here, the keyword table 220 may be generated based on design specifications of the IT system, a source program, etc.

As described, the analysis support apparatus 100 according to the second embodiment enables an activity whose name matches a preliminarily prepared keyword K to be detected from among a series of activities A1 to An executed by the system 200. The analysis support apparatus 100 further enables other activity names that do not match a keyword K to be accumulated in the weight table 1000, as a keyword candidate related to a business process Pj, if an activity whose name matches a keyword K is detected.

The analysis support apparatus 100 enables a weight indicative of the degree of relevancy between the business process Pj and an activity name that does not match a keyword to be calculated based on execution intervals between activities in the series of activities A1 to An. Consequently, keyword candidates related to the business process Pj can be narrowed down to keywords having a high potential of being related to the business process Pj.

The analysis support apparatus 100 enables a weight wi, which is indicative of the degree of relevance between the name of an activity Ai and the business process Pj, to be calculated based on the frequency at which the activity Ai is included in a process instance correlated with the business process Pj. Consequently, the keyword candidates related to the business process Pj can be narrowed down to keywords having a high potential of being related to the business process Pj.

The analysis support apparatus 100 enables a level of association Vj indicative of the degree of relevancy between the business process Pj and the activities A1 to An to be calculated based on the weights wi respectively for each of the activities A1 to An. Consequently, the weights wi are determined for the activities A1 to An collectively, enabling determination of the degree of relevancy between the business process Pj and the activities A1 to An.

The analysis support apparatus 100 enables the activities A1 to An and the business process Pj to be correlated based on the level of association Vj, which is indicative of the degree of relevancy between the business process Pj and the activities A1 to An. Consequently, when multiple business process candidates correlated with the activities A1 to An are present, a more proper business process Pj can be selected for correlation.

The analysis support apparatus 100 enables the weight wi indicative of the degree of relevancy between the name of an activity Ai and the business process Pj to be corrected based on the number of business processes related to the activity Ai. Consequently, a weight indicative of the degree of relevancy between a general activity and the business process Pj can be estimated to be of a low value, from which the level of association Vj indicative of the degree of relevancy between the business process Pj and the activities A1 to An can be calculated.

The analysis support apparatus 100 enables correspondence rules for the business process Pj and a process instance to be dynamically changed by using weight data that is accumulated and updated in the weight table 1000. The analysis support apparatus 100 enables process instances that could not be correlated with a business process Pj to be re-evaluated at an arbitrary timing, by using weight data that has been updated in the weight table 1000.

Therefore, according the analysis program, the analysis support method, the analysis support apparatus, and the system, the collection of process instances of each business process Pj can be performed efficiently and effectively, enabling improved accuracy of the analysis of the business processes Pj.

If the process instance data includes an execution machine identifier, analysis of which component (e.g., a servlet, an EJB, etc.) in the IT system is related to which flow of which business process can be performed. Consequently, the effects that a failure of a component in the IT system has on an operation can be determined.

For example, if 2 components operated by the same business process fails, a priority sequence can be set that preferentially copes with an occurring failure by a normally functioning route. Further, a countermeasure by operation that suspends flow at an activity immediately before an activity where trouble has occurred becomes possible.

Concerning the business process Pj for which only normal routes of activities matching preliminarily prepared keywords could be detected in the description thus far, the detection of abnormal routes that do not match a keyword K can be detected. As a result, when advancement along an abnormal route is undesirable, by analyzing the cause, the business process Pj can be improved.

The analysis support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute an analysis support process comprising:
storing to a storage device, a name of a second process that is a process included among a plurality of processes called in response to execution of a program, the computer storing the name of the second process when a first process having a name that matches a keyword stored in a storage device is included among the processes.

2. The computer-readable recording medium according to claim 1, the analysis support process further comprising
correlating with the program and storing to the storage device, the keyword and the name of the second process.

3. A computer-readable recording medium having stored therein a program for causing a computer to execute an analysis support process comprising:
detecting based on contents of a storage device storing keywords related to information processing implemented by an execution of 2 or more tasks, a first task having a name that matches a keyword stored in the storage device, the computer detecting the first task from among a series of tasks executed in a system; and
registering into the storage device as a keyword related to the information processing, a name of a second task that is different from the first task and among the series of tasks, the computer registering the name of the second task when the first task is detected.

4. The computer-readable recording medium according to claim 3, wherein
the storage device stores a first value that is indicative of degree of relevancy between the keyword that matches the name of the first task and the information processing,
the analysis support process further comprising:
calculating a second value that is indicative of the degree of relevancy between the name of the second task and the information processing, the computer calculating the second value based on the first value and execution orders of the first task and the second task within the series of tasks; and
correlating and storing to the storage device, by the computer, the calculated second value and the name of the second task registered as a keyword related to the information processing.

5. The computer-readable recording medium according to claim 3, the analysis support process further comprising:
correlating, by the computer, the series of tasks and the information processing, when the first task is detected; and
outputting by the computer, a correlation result obtained at the correlating of the series of tasks and the information processing.

6. The computer-readable recording medium according to claim 5, the analysis support process further comprising
calculating a level of association indicative the degree of relevancy between the information processing and the series of tasks, the computer calculating the level of association when multiple first tasks are detected and based on values indicative of the degree of relevancy between the information processing and each keyword that is stored in the storage device and that matches the name of a task among the detected tasks, wherein
the correlating of the series of tasks and the information processing includes correlating the series of tasks and the information processing, based on the calculated level of association.

7. The computer-readable recording medium according to claim 5, the analysis support process further comprising:
incrementing, in a table storing an occurrence count for the information processing and an occurrence count for each of the keywords related to the information processing, the occurrence count of each keyword that matches the name of a task among the series of tasks, the computer performing the incrementing when the series of tasks and the information processing have been correlated;
calculating by the computer and based on the occurrence counts of the information processing and of each of the keywords matching the name of a task among the series of tasks, values indicative of the degree of relevancy between the information processing and the names of the tasks series of tasks; and
correlating and storing to the storage device by the computer, the calculated values and each of the keywords matching the name of a task among the series of tasks.

8. The computer-readable recording medium according to claim 6, wherein
the calculating of the level of association indicative of the degree of relevancy between the information processing and the series of tasks, by the computer calculating values indicative of the degrees of relevancy between the information processing and each keyword that is stored in the storage device and that matches the name of a task among the series of tasks.

9. The computer-readable recording medium according to claim 8, the analysis support process further comprising
correcting the values indicative of the degree of relevancy between the information processing and each keyword that is stored in the storage device and that matches the name of a task among the series of tasks, the computer correcting the values based on a count of the information processings that are in the storage device and for which a value indicative of the degree of relevancy with a keyword that matches the name of a task is stored, wherein
the calculating of the level of association includes calculating the level of association by the computer adding the values corrected at the correcting.

10. An analysis support method executed by a computer, the analysis support method comprising:
detecting based on contents of a storage device storing keywords related to information processing implemented by an execution of 2 or more tasks, a first task having a name that matches a keyword stored in the storage device, the computer detecting the first task from among a series of tasks executed in a system; and
registering into the storage device as a keyword related to the information processing, a name of a second task that is different from the first task and among the series of tasks, the registering being performed by the computer when the first task is detected.

11. An analysis support apparatus comprising:
a storage device storing keywords related to information processing implemented by an execution of 2 or more tasks; and
a processor that:
detects from among a series of tasks executed in a system, a first task having a name that matches a keyword related to the information processing stored in the storage device, and
registers into the storage device as a keyword related to the information processing when the first task has been detected, a name of a second task that is different from the first task and among the series of tasks.

12. A system comprising:
a storage device storing keywords related to information processing implemented by an execution of 2 or more tasks; and
a processor that:
executes a series of tasks,
detects from among the executed series of tasks, a first task having a name that matches a keyword related to the information processing stored in the storage device, and
registers into the storage device as a keyword related to the information processing when the first task has been detected, a name of a second task that is different from the first task and among the series of tasks.
